(19) United States
(12) Patent Application Publication
(10) Pub. No.: US 2018/0215392 A1
(43) Pub. Date: Aug. 2, 2018

(54) VEHICLE CONTROL DEVICE AND VEHICLE CONTROL METHOD

(71) Applicant: DENSO TEN Limited, Hyogo (JP)

(72) Inventors: Tomohiro Kosaka, Kobe-shi (JP); Minoru Maehata, Kobe-shi (JP); Hiroshi Yamashita, Kobe-shi (JP); Mana Tsuji, Kobe-shi (JP); Hiroshi Sakate, Kobe-shi (JP); Kei Sezaki, Kobe-shi (JP); Ryo Miyamoto, Kobe-shi (JP)

(73) Assignee: DENSO TEN Limited, Hyogo (JP)

(21) Appl. No.: 15/887,325

(22) Filed: Feb. 2, 2018

(30) Foreign Application Priority Data
Feb. 2, 2017 (JP) 2017-017519
Feb. 2, 2017 (JP) 2017-017598

(51) Int. Cl. B60W 50/12; G05D 1/00; G05D 1/02

(52) U.S. Cl. CPC B60W 50/12; G05D 1/0088; B60W 2540/28; G05D 2201/0213; G05D 1/0276

(57) ABSTRACT

A vehicle control device has a plurality of driving modes with different allowable operation ranges for operating a vehicle. The plurality of driving modes include at least an automatic driving mode. A vehicle control device 10 includes a processing unit that determines that the vehicle is to fee operated in any one of the plurality of driving modes based on the driver qualification information possessed by an occupant who operates the vehicle.

### CROSS-REFERENCE TO RELATED APPLICATIONS

This application is based upon and claims the benefit of priority of the prior Japanese Patent Applications No. 2017-017598 and No. 2017-017519, filed on Feb. 2, 2017, the entire contents of which are incorporated herein by reference.

### FIELD

The present invention relates to a vehicle control device and a vehicle control method.

### BACKGROUND

Conventionally, an autonomous vehicle that is driven automatically without driver's driving operation has been developed.

For a manually driven vehicle operated by a driver, it is required that the driver possesses a driver's license. This is because it is considered that the driver can safely operate the manually driven vehicle owing to a specified driving operation technique which is supposed to be acquired by the driver.

Further, the autonomous vehicle sometimes has a manual driving mode for moving a vehicle by manual driving as well as an automatic driving mode for moving a vehicle by automatic driving. This is because some drivers want to manually control the vehicle.

For example, it is proposed to ask a driver who boards the autonomous vehicle to possess a driver's license (For example, see Japanese Patent Application Laid-Open No. 2016-130091).

However, it is also expected that an occupant who does not possess a driver's license will board the autonomous vehicle.

For example, use of the autonomous vehicle is expected in depopulated areas where public transportation is scarce. Those who wish to use the autonomous vehicle in such an area do not have a driver's license in some cases.

The autonomous vehicle has a function of automatically driving the vehicle to a destination if the occupant inputs his/her destination even if the occupant does not possess a driver's license.

However, when the occupant does not possess a driver's license, the occupant is not allowed to operate the autonomous vehicle by manual driving.

### SUMMARY

An object of the present disclosure is to provide a vehicle control device and a vehicle control method, capable of determining an allowable operation range for an occupant to operate a vehicle having an automatic driving mode.

According to the present disclosure, there is provided a vehicle control device; including:

a plurality of driving modes with different allowable operation ranges for an occupant to operate a vehicle, the driving modes including at least an automatic driving mode based on driver qualification information possessed by an occupant who operates the vehicle; and

a processing unit that determines to operate the vehicle in any one of the plurality of driving modes and controls the vehicle based on the determined driving mode.

Further, according to the present disclosure, there is provided a vehicle control method, including:

determining to operate a vehicle by a processing unit in any one of a plurality of driving modes with different allowable operation ranges for an occupant to operate the vehicle, based on driver qualification information possessed by the occupant who operates the vehicle, the driving modes including at least an automatic driving mode.

According to the abovementioned disclosure, there is provided the vehicle control device, capable of determining the allowable operation range for the occupant to operate the vehicle having the automatic driving mode, based on the occupant's driver qualification information.

Further, according to the above mentioned disclosure, there is provided the vehicle control method, including determining the allowable operation range for the occupant to operate the vehicle having the automatic driving mode, based on the occupant's driver qualification information.

### BRIEF DESCRIPTION OF DRAWINGS

FIG. 1 is a diagram illustrating a vehicle control system according to an embodiment of the present disclosure.

FIG. 2A is a functional block diagram of a processing unit of a vehicle control device.

FIG. 2B is a diagram illustrating a storage unit of the vehicle control device.

FIG. 3 is a flowchart (part 1) for explaining an operation of the vehicle control device.

FIG. 4 is a diagram illustrating a screen displayed on a display unit of an in-vehicle device.

FIG. 5 is a flowchart (part 2) for explaining the operation of the vehicle control device.

FIG. 6 is a flowchart (part 3) for explaining the operation of the vehicle control device.

FIG. 7 is a flowchart (part 4) for explaining the operation of the vehicle control device.

FIG. 8 is a diagram illustrating a vehicle control network system according to an embodiment of the present disclosure.

FIG. 9 is a diagram illustrating a vehicle control network system according to an embodiment of the present disclosure.

FIG. 10 is a functional block diagram of a processing unit of the vehicle control device.

FIG. 11 is a diagram for explaining a storage unit.

FIG. 12 is a diagram illustrating the storage unit.

FIG. 13 is a diagram illustrating a driver qualification information table.

FIG. 14 is a flowchart (part 1) for explaining an operation of the vehicle control network system.

FIG. 15 is a sequence diagram (part 1) illustrating the operation of the vehicle control network system.

FIG. 16 is a diagram illustrating a screen displayed on a display unit of the in-vehicle device.

FIG. 17 is a flowchart (part 2) for explaining the operation of the vehicle control network system.

FIG. 18 is a diagram illustrating a manual driving history table

FIG. 19 is a diagram, illustrating the screen of the display unit when automatic driving evaluation information is acquired.

FIG. 20 is a sequence diagram (part 2) illustrating the operation of the vehicle control network system.

FIG. 21 is a sequence diagram (part 3) illustrating the operation of the vehicle control network system.

FIG. 22 is a sequence diagram (part 4) illustrating the operation of the vehicle control network system.

### DESCRIPTION OF EMBODIMENTS

A first preferred embodiment of the vehicle control system according to the present disclosure will be described hereafter, with reference to the drawings. However, a technical scope of the present invention is not limited to those embodiments, but extends to the invention described in the claims and equivalents thereof.

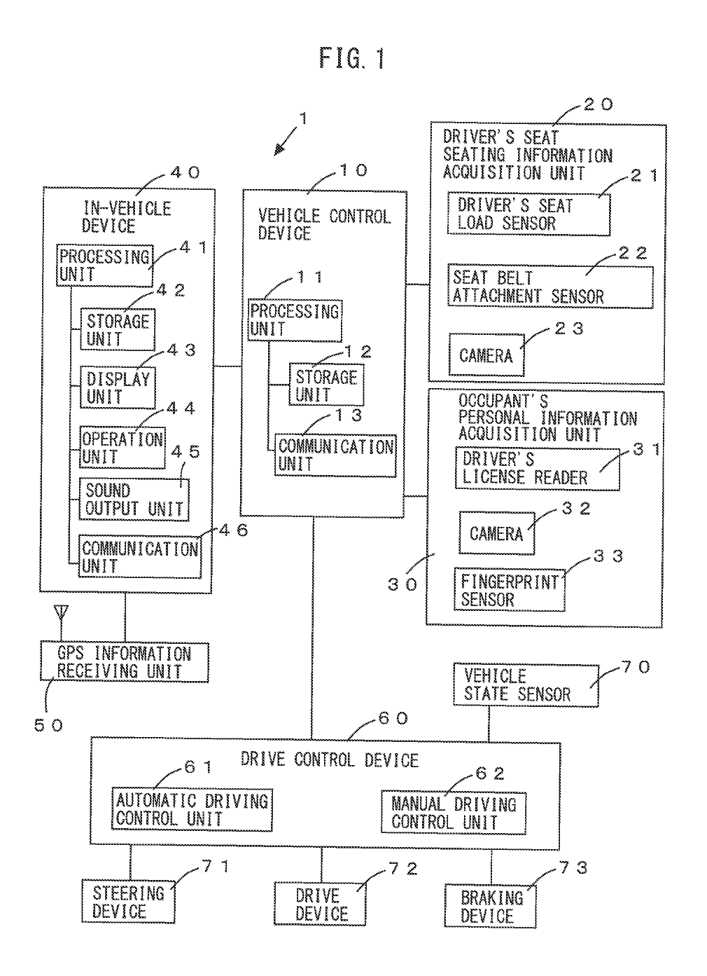

FIG. 1 is a diagram illustrating a vehicle control system according to an embodiment of the present disclosure.

A vehicle control system 1 (hereinafter, also simply referred to as a system 1) controls an operation of a vehicle having an automatic driving mode for driving a vehicle by automatic driving without occupant's own driving operation, and a manual driving mode for driving a vehicle by occupant's own driving operation. In this embodiment, the system 1 is installed in a vehicle having four wheels.

In the automatic driving mode, an operation of a main control system including steering, acceleration, and braking of the vehicle is automatically performed. In the manual driving mode, the operation of the abovementioned main control system of the vehicle is performed by an occupant who is seated in the driver's seat.

An allowable operation range for the occupant to operate the vehicle, is different between the automatic driving mode and the manual driving mode. For example, in the automatic driving mode, the occupant is allowed to input a destination, but is not allowed to operate a main control system including steering, acceleration and braking of the vehicle. In contrast, in the manual driving mode, the occupant is allowed to operate the main control system.

In the system 1, the driving mode is determined based on the driver qualification information possessed by the occupant who is seated in the driver's seat of the vehicle. The vehicle can be controlled by the determined driving mode.

The system 1 includes a vehicle control device 10, a driver's seat seating information acquisition unit 20, an occupant's personal information acquisition unit 30, and an in-vehicle device 40. Further, the system 1 includes a driving control device 60 and a vehicle state sensor 70.

The vehicle control device 10 detects that the occupant is seated in the driver's seat based on the information acquired by the driver's seat seating information acquisition unit 20. Further the vehicle control device 10 recognizes the driver qualification information possessed by the occupant who is seated in the driver's seat based on the occupant's personal information acquired by the occupant's personal information acquisition unit 30.

Based on the recognized driver qualification information, the vehicle control device 10 determines an allowable driving mode for the occupant (occupant operating the vehicle) who is seated in the driver's seat to operate the vehicle, based on the recognized driver qualification information.

A destination is input in the vehicle control device 10 using the in-vehicle device 40 and a route from a current position to the destination is searched, so that the vehicle can run on the route in the allowable driving mode.

The vehicle control device 10 causes the driving control device 60 to control the operation of the vehicle.

The vehicle control device 10 includes a processing unit 11, a storage unit 12, and a communication unit 13.

The processing unit 11 includes one or a plurality of processors and peripheral circuits. The processing unit 11 controls each hardware component of the vehicle control device 10 and performs various processing in accordance with a predetermined program 12a previously stored in the storage unit 12 which is used for temporarily storing data generated during processing.

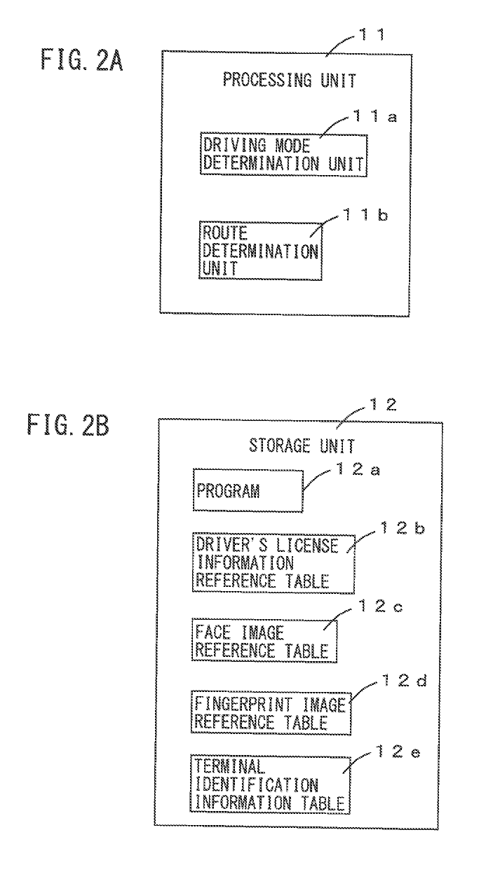

FIG. 2A is a functional block diagram of a processing unit of a vehicle control device. FIG. 2B is a diagram illustrating a storage unit of the vehicle control device.

The processing unit 11 has a driving mode determination unit 11a and a route determination unit 11b.

These units of the processing unit 11 are, for example, function modules realized by a computer program operating on a processor of the processing unit 11. These units of the processing unit 11 may be installed in the vehicle control device 10 as separate circuits, respectively. The explanation of each part will be described later.

The storage unit 12 may include a semiconductor memory such as a random access memory (RAM) or a read only memory (ROM), or a magnetic disk or a flash memory. The storage unit 12 may have a drive capable of reading out a predetermined program 12a from a storage medium that stores the predetermined program 12a.

The storage unit 12 stores a predetermined program 12a, a license information reference table 12b, a face image reference table 12c, a fingerprint image reference table 12a, a terminal identification information table 12e, and the like which will be described later.

The communication unit 13 transmits and receives information to and from the driver's seat seating information acquisition unit 20, the occupant's personal information acquisition unit 30, the in-vehicle device 40, and the driving control device 60. The processing unit 11 performs various processing based on the information received using the communication unit 13. Further, the processing unit 11 transmits the result of performing various processing using the communication unit 13.

Further, the communication unit 13 may be communicable with outside via a network (not illustrated), using wireless communication. The communication unit 13 may have a communication circuit and a communication line or an antenna that performs transmission and reception.

The driver's seat seating information acquisition unit 20 acquires information indicating a seating state of the driver's seat of the vehicle and transmits information indicating presence or absence of seating, to the vehicle control device 10. The driver's seat seating information acquisition unit 20 includes a driver's seat load sensor 21, a seat belt attachment sensor 22, and a camera 23. However, the driver's seat seating information acquisition unit 20 may not be required to have all of these sensors or the like. In addition, the driver's seat seating information acquisition unit 20 may have other means for detecting that the occupant is seated in the driver's seat of the vehicle.

When the driver's seat load sensor 21 detects a load equal to or greater than a predetermined value in the driver's seat of the vehicle, the driver's seat load sensor 21 transmits a signal to the vehicle control device 10 to notify that detection.

When detecting that the seat belt placed in the driver's seat of the vehicle is worn by the occupant, the seat belt attachment sensor 22 transmits a signal to the vehicle control device 10 to notify the vehicle control device 10 of that detection.

The camera 23 captures an image including the driver's seat of the vehicle and transmits the captured image to the vehicle control device 10.

The occupant's personal information acquisition unit 30 acquires occupant's personal information for recognizing the occupant who is seated in the driver's seat of the vehicle and transmits the acquired occupant's personal information to the vehicle control device 10. The occupant's personal information is used for determining the occupant's driver qualification information. Examples of the occupant's personal information include information held by a driver's license, and biometric information such as an image of an occupant's face, an occupant's fingerprint, and the like. Specifically, the occupant's personal information acquisition unit 30 includes a driver's license reader 31, a camera 32, and a fingerprint sensor 33. However, the occupant's personal information acquisition unit 30 may not be required to have all of these sensors and the like. Further, the occupant's personal information acquisition unit 30 may have other means for acquiring occupant's personal information.

The driver's license reader 31 acquires the information held by an IC card type driver's license of the occupant who is seated in the driver's seat of the vehicle, and transmits the acquired information to the vehicle control device 10 as occupant's personal information. The driver's license reader 31 is disposed, for example, below a dashboard in front of the driver's seat of the vehicle. The occupant who is seated in the driver's seat of the vehicle holds a carried IC card type driver's license close to the driver's license reader 31 or, making it contact with the driver's license reader 31, to thereby make it read the information held by the driver's license. For example, an RFID reader can be used as the driver's license reader 31.

Examples of the information held by the driver's license include the driver's license qualification such as a regular car classification license (manual, no limitation), a regular car classification license (limited to automatic), a regular motorcycle license etc., and the age of an occupant, etc.

The camera 32 captures an image including the driver's seat of the vehicle and transmits the captured image to the vehicle control device 10 as the occupant's personal information. The camera 32 may be the same as the camera 23.

The fingerprint sensor 33 acquires an image of a fingerprint of an occupant who is seated in the driver's seat of the vehicle, and transmits the acquired image to the vehicle control device 10 as occupant's personal information. As the fingerprint sensor 33, for example, a capacitance type can be used. The occupant who is seated in the driver's seat of the vehicle, for example, causes the fingerprint sensor 33 to read the fingerprints.

The in-vehicle device 40 includes a processing unit 41, a storage unit 42, a display unit 43, an operation unit 44, a sound output unit 45, and a communication unit 46. The in-vehicle device 40 is operable under control of the vehicle control device 10.

The processing unit 41 includes one or a plurality of processors and peripheral circuits. The processing unit 41 controls each hardware component of the in-vehicle device 40 and performs various processing in accordance with a predetermined program previously stored in the storage unit 42 which is used for temporarily storing data generated during processing.

The storage unit 42 may have a semiconductor memory such as a random access memory (RAM) or a read only memory (ROM), or a nonvolatile memory such as a magnetic disk or a flash memory. Further, the storage unit 42 may use a disk drive as a drive capable of reading a predetermined program from a non-transitory storage medium that stores the predetermined program.

The display unit 43 is disposed in a center console and can display various kinds of information associated with the operation of the in-vehicle device 40, under control of the processing unit 41. As the display unit 43, for example, a liquid crystal display can be used. The display unit 43 is used for displaying information, also in the processing of the vehicle control device 10.

The operation unit 44 is operated by the occupant so that an operation can be input. For example, a touch panel disposed on the screen of the display unit 43 can be used as the operation unit 44 in the in-vehicle device 40. The operation unit 44 is used by the occupant so that an operation can be input, also in the processing of the vehicle control device 10.

The sound output unit 45 has a speaker (not illustrated), and outputs sound under control of the processing unit 41. The sound output unit 45 is used for outputting sound, also in the processing of the vehicle control device 10.

The communication unit 46 communicates with the vehicle control device 10 and the in-vehicle network (compliant with the controller area network (CAN)) installed in the vehicle. Further, the communication unit 46 may be communicable with the outside via a network (not illustrated), using wireless communication. The communication unit 46 may include a communication circuit and a communication line or an antenna that performs transmission and reception. The communication unit 46 may be used together with the communication unit 13.

Further, in the in-vehicle device 40, position information indicating a position of the vehicle is input from a GPS information receiving unit be installed in the vehicle. The GPS information receiving unit 50 receives GPS radio waves transmitted by a GPS satellite, obtains a position of the vehicle, and outputs a vehicle position information to the in-vehicle device 40.

The processing unit 41 has a navigation function. The navigation function is a functional module realized using map data stored in the storage unit 42, by executing the program also stored in the storage unit 42, and performs route guidance to the destination based on a current position of the vehicle acquired from the GPS information receiving unit 50. The processing unit 41 generates a map image indicating a map of the surroundings of the vehicle and voice guidance information, based on the map data stored in the storage unit 42 and the position of the vehicle. Further, when the destination is set by the occupant, the processing unit 41 derives a route from the current position of the vehicle to the destination, and superimposes the route on the map image. The map image generated by the processing unit 41 is displayed on the display unit 43.

The storage unit 42 stores road information on the stored map data, road information for allowing running by automatic driving, and road information for not allowing running by automatic driving, in association with each other. For example, although running on the expressways by automatic driving is allowed, running on regular roads by automatic driving is not allowed in some cases.

Based on a notification from the vehicle control device 10, the processing unit 41 of the in-vehicle device 40 generates a route from the current position of the vehicle to the destination. Further, based on the notification from the vehicle control device 10, the processing unit 41 can generate a route via only roads that allow running by automatic driving. The processing unit 41 of the in-vehicle device 40 may derive a plurality of routes and may determine one route selected by the occupant as a route.

Further, the processing unit 41 may derive the route so as to go through a point or a road designated by the occupant.

The driving control device 60 switches the driving mode between the automatic driving mode and the manual driving mode to control the vehicle, under control of the vehicle control device 10. The drive control device 60 has an automatic driving control unit 61 and a manual driving control unit 62. In the automatic driving mode, the drive control device 60 outputs a control signal generated by the automatic driving control unit 61 to a steering device 71, a drive device 72, and a braking device 73 described later. Further in the manual driving mode, the drive control device 60 generates signals to be output to the steering device 71, the drive device 72, and the braking device 73 based on the operation by the occupant.

The vehicle state sensor 70 includes for example a sensor for detecting a state of a vehicle such as a vehicle speed sensor, a steering angle sensor, a lateral acceleration sensor, a yaw rate sensor, a wheel speed sensor, and an engine speed sensor. Further, the vehicle state sensor 70 includes a sensor for detecting a circumstance of the vehicle such as a camera, a radar or the like. Information detected by the vehicle state sensor 70 is output to the drive control device 60.

The automatic driving control unit 61 controls the operation of the vehicle by automatic driving, by controlling the steering device 71, the drive device 72 and the braking device 73, which will be described later, based on information such as the vehicle speed, the lateral, acceleration, the yaw rate detected by the vehicle state sensor 70, the image captured by the camera, and a reflected wave measured by the radar. Further, the route information generated by the in vehicle device 40 is input in the automatic driving control unit 61 using the vehicle control device 10, and a running direction is determined.

The manual driving control unit 62 controls the operation of the vehicle by manual driving, by controlling the steering device 71, the drive device 72 and the braking device 73, which will be described later, based on the operation to a steering wheel, an accelerator pedal, a brake pedal, etc. (not illustrated) by the occupant who is seated in the driver's seat.

The steering device 71 determines the running direction of the vehicle based on the control signal of the automatic driving control unit 61 or the manual driving control unit 62.

The drive device 72 generates a driving force of the vehicle based on the control signal of the automatic driving control unit 61 or the manual driving control unit 62 to accelerate the vehicle. The drive device 72 has, for example, an internal combustion engine or an electric motor.

The braking device 73 generates the braking force of the vehicle based on the control signal of the automatic driving control unit 61 or the manual driving control unit 62. The braking device 73 has, for example, a brake disc, a brake caliper and a hydraulic mechanism.

The vehicle control device 10 in the system 1 has a manual MT driving mode, a manual AT driving mode, a speed and route selecting automatic driving mode, and a fully automatic driving mode, as allowable driving modes for the vehicle in which it is installed.

The manual MT driving mode is one of the manual driving modes. Namely, the manual MT driving mode is the driving mode for manually operating the vehicle by an occupant's own operation of changing a gear by operating a shift lever and a clutch pedal not illustrated. The manual MT driving mode is a so-called driving mode of a manual vehicle.

The manual AT driving mode is another one of the manual driving modes. The manual AT driving mode is the driving mode for manually operating the vehicle by an occupant's own operation, with the gear change operation controlled by the manual driving control unit 62. The manual AT driving mode is a so-called driving mode of an automatic vehicle.

Speed and route selecting automatic driving mode is one of the automatic driving modes. The speed and route selecting automatic driving mode is the driving mode for automatically driving the vehicle in which the occupant is allowed to select a destination, a route, and a speed setting operation. The speed selection means to specify the speed at which the vehicle runs within a range of a speed limit or less. The route selection means to derive a route so as to go through a point or a road designated by the occupant during derive of a route.

The fully automatic driving mode is another one of the automatic driving modes. The fully automatic driving mode is the driving mode for automatically driving the vehicle in which the occupant is allowed to perform only setting of the destination.

The operation of the abovementioned system 1 will be described hereafter with reference to the drawings.

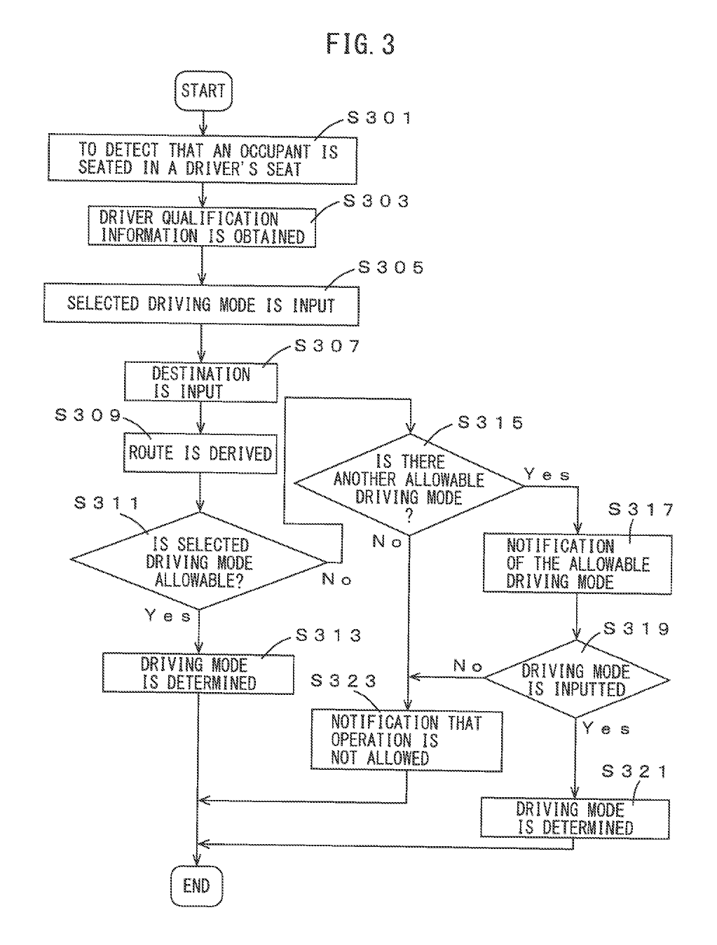

FIG. 3 is a flowchart for explaining a processing of determining the driving mode by the vehicle control device 10.

First, in step S301, the driving mode determination unit 11a of the processing unit 11 of the vehicle control device 10 detects that the occupant is seated in the driver's seat of the vehicle based on the information obtained from the driver's seat seating information acquisition unit 20.

The driving mode determination unit 11a may detect that the occupant is seated in the driver's seat of the vehicle based on the signal transmitted from the driver's seat load sensor 21.

Further, based on the signal transmitted from the seat belt attachment sensor 22, the driving mode determination unit 11a may detect that the occupant is seated in the driver's seat of the vehicle.

Further, based on the image transmitted from the camera 23, the driving mode determination unit 11a may detect that the occupant is seated in the driver's seat of the vehicle. For example, the driving mode determination unit 11a may detect the occupant who is seated in the driver's seat of the vehicle by analyzing the image using an identifier of a support vector machine or adaBoost.

When detecting that the occupant is seated in the driver's seat of the vehicle, the driving mode determination unit 11a may use one or more of the means for acquiring the plurality of driver's seat seating information described above. When multiple means are used, seating of the occupant may be detected using a majority voting method.

Next, in step S303, the driving mode determination unit 11a, which detects that the occupant is seated in the driver's seat of the vehicle, recognizes the driver qualification information possessed by the occupant who is seated in the driver's seat of the vehicle, based on the occupant's personal information acquired by the occupant's personal information acquisition unit 30.

The driving mode determination unit 11a may obtain the driver qualification information based on the occupant's personal information held by the driver's license acquired by the driver's license reader 31. The storage unit 12 of the vehicle control device 10 stores a driver qualification information reference table 12b in which the driver's license qualification held by the driver's license and the driver qualification information are registered in association with each other. The driving mode determination unit 11a obtains the occupant's driver qualification information, with reference to the driver qualification information reference table 12b, based on the driver qualification information held by the driver's license. The driver qualification information registered in the license information reference table 12b, includes for example a regular car classification license (manual, no limitation), a regular car classification license (limited to automatic), and a regular motorcycle license etc. As described above, the driving mode determination unit 11a automatically determines the driver qualification information possessed by the occupant who is seated in the driver's seat of the vehicle, based on a driver's license which is a public certificate.

In a case of the regular car classification license (manual, no limitation) as the driver qualification information, all modes of the abovementioned four manual MT driving modes, the manual AT driving mode, the speed and route selecting automatic driving mode, and the fully automatic driving mode are allowed for the occupant, as the driving modes.

In a case of the regular car classification license (limited to automatic) as the driver qualification information, the manual AT driving mode, the speed and the route selecting automatic driving mode, and the fully automatic driving mode among the abovementioned four driving modes are allowed for the occupant, as the driving modes.

In a case of the regular motorcycle license as the driver qualification information, the speed and route selecting automatic driving mode and the fully automatic driving mode among the abovementioned four driving modes are allowed for the occupant, as the driving modes. The occupant who has the regular motorcycle license is considered to grasp traffic regulations such that there is a speed limit on the road and that a predetermined direction is only possible on a one way road. Therefore, the operation of speed and route selection is allowed for the occupant. However, in a case of the regular motorcycle license, the manual driving of a vehicle having four wheels is not allowed, and therefore the manual driving mode is not allowed for the occupant.

The above description of the driver qualification information is also applied to the face image reference table 12c and the fingerprint image reference table 12d described later as appropriate.

Further, the driving mode determination unit 11a may determine the driver qualification information, based on the driver's license qualification and the occupant's age as the occupant's personal information held by the driver's license and acquired by the driver's license reader 31. For example, when the occupant's age is equal to or more than a predetermined age, the driving mode allowed for the occupant may be limited to only the speed and route selecting automatic driving mode or the fully automatic driving mode, even if the occupant has the regular car classification license (manual, no limitation) or the regular car classification license (limited, to automatic). From a viewpoint of ensuring safe running of the vehicle, it is acceptable that manual driving is not allowed for older occupants, even they have the driver qualification information that allows the manual driving.

When the driver's license reader 31 cannot acquire the occupant's personal information from the driver's license within a predetermined time after detecting that the occupant is seated in the driver's seat of the vehicle, the driving mode determination unit 11a judges that the occupant does not have a driver's license. In other words, the driving mode determination unit 11a judges that the occupant does not have a driver qualification, as the driver qualification information.

When the occupant does not have a driver qualification as the driver qualification information, the driving mode determination unit 11a may determine the driving mode so that the fully automatic driving mode is allowed or no one of the abovementioned driving modes is allowed among the abovementioned four driving modes. The occupant who is not allowed to drive the vehicle in any one of the abovementioned driving modes, cannot operate the vehicle.

The explanation for the relationship between the abovementioned driver qualification information and the allowable driving mode is also applied as appropriate, to the explanation for the method for determining other operation driver qualification information.

Further, the driving mode determination unit 11a may obtain an image of the face of the occupant who is seated in the driver's seat of the vehicle as occupant's personal information, based on the image transmitted from the camera 32. The storage unit 12 of the vehicle control device 10 has a face image reference table 12c in which face image information and the driver qualification information are registered in association with each other. The driving mode determination unit 11a obtains the driver qualification information associated with the image of the occupant's face acquired as the occupant's personal information, with reference to the face image reference table 12c. The driver qualification information registered in the face image reference table 12c is the same as that of the license information reference table 12b.

The driving mode determination unit 11a analyzes the image of the occupant's face acquired as the occupant's personal information, for example, using an eigenface method using principal component analysis, a linear discriminant analysis method, an elastic bunching graph matching method, a hidden Markov model method, and a dynamic link matching method by neuron motivation.

When the driving mode determination unit 11a cannot acquire the driver qualification information based on the image of the occupant's face acquired as the occupant's personal information, the driving mode determination unit 11a judges that the occupant does not have a driver qualification, as the driver qualification information.

Further, based on the linage transmitted from the fingerprint sensor 33, the driving mode determination unit 11a may obtain the image of the fingerprint of the occupant who is seated in the driver's seat of the vehicle, as the occupant's personal information. The storage unit 12 of the vehicle control device 10 has a fingerprint image reference table 12d in which a fingerprint image information and driver qualification information are registered in association with each other. The driving mode determination unit 11a obtains the driver qualification information associated with the occupant's fingerprint image information acquired as the occupant's personal information, with reference to the fingerprint image reference table 12d.

The driving mode determination unit 11a analyzes the image of the occupant's fingerprint acquired as the occupant's personal information, for example using pattern matching or minutia matching.

When the driving mode determination unit 11a cannot acquire the driver qualification information based on the image of the occupant's fingerprint acquired as the occupant's personal information, the driving mode determination unit 11a judges that the occupant does not have a driver qualification, as the driver qualification information.

When acquiring the driver qualification information, the driving mode determination unit 11a may use one or more of the means for acquiring the abovementioned plurality of occupant's personal information. When using the means for acquiring a plurality of occupant's personal information, and when all of the acquired driver qualification information do not match with each other, it may be so judged that the occupant does not have a driver qualification, as the driver qualification information.

For example, the driving mode determination unit 11a may determine the driver qualification information based on the information held by the driver's license acquired by the driver's license reader 31 and the image of the occupant's face transmitted from the camera 32. When it is assumed that a child of an owner of the vehicle takes out an owner's driver's license and is seated in the driver's seat of the vehicle, the driver qualification information obtained based on the occupant's personal information acquired by the driver's license reader 31, and the driver qualification information acquired based on the image of the occupant's face transmitted from the camera 32, do not match with each other. Thus, when the plurality of acquired driver qualification information do not match with each other, the driving mode determination unit 11a may not allow any occupant to operate in any driving mode. In this case, the child cannot operate the vehicle.

When it is detected that the occupant seated in the driver's seat of the vehicle has unseated, the driving mode determination unit 11a preferably acquires the driver qualification information again by performing processing of steps S301 and S303 again, based on the information transmitted from the driver's seat seating information acquisition unit 20.

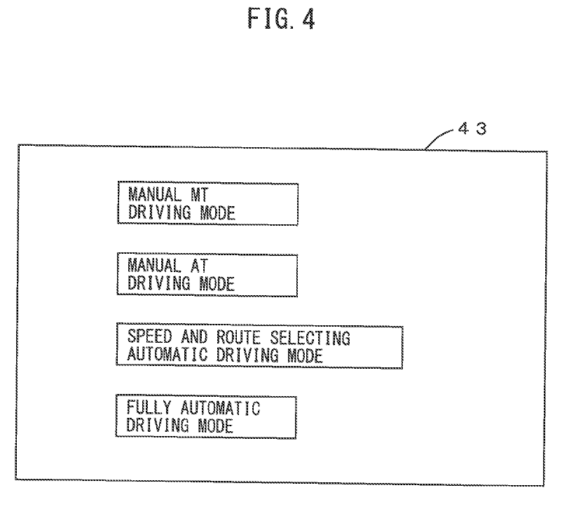

Next, in step S305, as illustrated in FIG. 4, the driving mode determination unit 11a displays all selectable driving modes of the vehicle, on the display unit 43 of the in-vehicle device 40. The occupant who is seated in the driver's seat of the vehicle selects one of the driving modes displayed on the display unit 43 by using the operation unit 44 of the in-vehicle device 40. Then, the driving mode selected by the occupant is input in the driving mode determination unit 11a. The driving mode determination unit 11a may display only the driving mode allowed for the occupant, on the display unit 43 based on the occupant's personal information.

Next, in step S307, a destination desired by the occupant who is seated in the driver's seat is input in the route determination unit 11b of the processing unit 11 of the vehicle control device 10, using the operation unit 44 of the in-vehicle device 40.

The occupant who is seated in the driver's seat inputs the destination using the operation unit 44 of the in-vehicle device 40. Further, the occupant who has selected the speed and the route selecting automatic driving mode may input the desired speed or route by using the operation unit 44 of the in-vehicle device 40.

Next, in step S309, the route determination unit 11b derives a route from a current position of the vehicle to the destination using the in-vehicle device 40.

The route determination unit 11b attempts to derive the routes only via roads allowed to run by automatic driving, when the driving mode selected by the occupant is the speed and route selecting automatic driving mode or the fully automatic driving mode. When it is impossible to derive the routes only via the roads allowed to run by automatic driving, or when the destination is not connected to the roads allowed to run by automatic driving, the route determination unit 11b derives alternative routes including the roads not allowed to run by automatic driving.

The occupant who is seated in the driver's seat may input a desired destination in the vehicle control device 10 using a terminal or the like (not illustrated) such as a high function portable terminal. In this case, only when the occupant's terminal and the communication unit 13 of the vehicle control device 10 or the communication unit 46 of the in-vehicle device 40 are connected by wire, input of the destination in the vehicle control device 10 may be allowed. A terminal identification information table 12e in which terminal identification information for identifying a terminal is registered, is stored in the storage unit 12 of the vehicle control device 10. Communication between the occupant's terminal and the communication unit 13 of the vehicle control device 10 or the communication unit 46 of the in-vehicle device 40, is allowed when the terminal identification information transmitted from the terminal is registered in the terminal identification information table 12e.

Thus, the destination is prevented from being input in the system 1 by a third party. Particularly, by allowing the destination to be input in the vehicle control device 10 only when connected by a wire, for example, while the occupant who is seated in a driver's seat is sleeping in the vehicle, it is not permitted for the third party to input the destination in the system 1 from outside the vehicle.

Next, in step S311, based on the driver qualification information, the driving mode determination unit 11a judges whether or not the selected driving mode is allowable for the derived route to the destination.

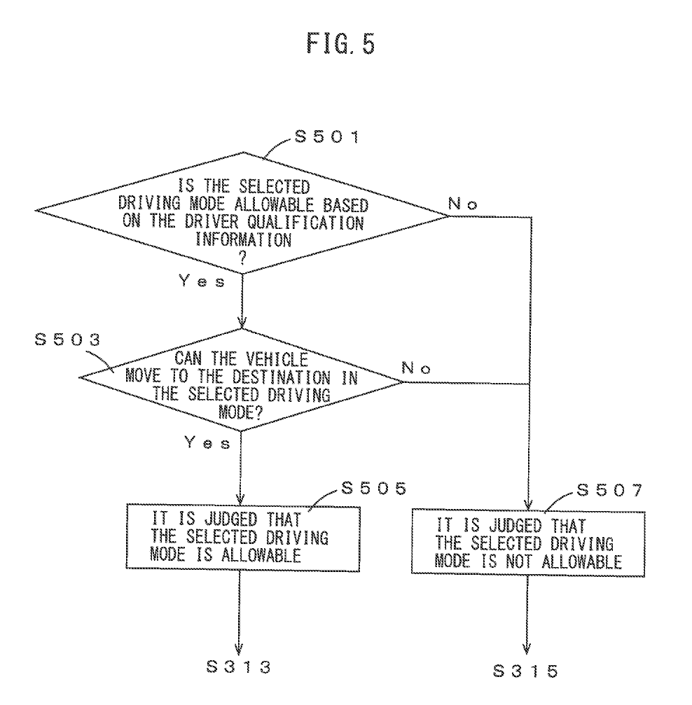

FIG. 5 is a diagram for explaining the processing of the driving mode determination unit 11a in step S311.

First, in step S501, the driving mode determination unit 11a judges whether or not the driving mode selected by the occupant is allowed based on the driver qualification information.

For example, when the occupant having the regular car classification license (manual, no limitation) as the driver qualification information, selects the manual MT driving mode, this selection is allowed (Yes in step S501). On the other hand, when the occupant having the regular car classification license (limited to automatic) as the driver qualification information, selects the manual MT driving mode, this selection is not permitted (No in step S501). Further, when the occupant having the regular motorcycle license as the driver qualification information selects the speed and route selecting automatic driving mode, this selection is allowed (Yes in step S501). On the other hand, when the occupant having the regular car classification license (limited to automatic) as the driver qualification information selects the manual MT driving mode or the manual AT driving mode, this selection is not allowed (No in step S501). Further, when the occupant who does not have a driver qualification as the driver qualification information selects the fully automatic driving mode, this selection is allowed (Yes in step S501). On the other hand, when the occupant who does not have a driver qualification as the driver qualification information selects the manual MT driving mode, the manual AT driving mode, or the speed and the route selecting automatic driving mode, this selection is not allowed (No in step S501).

Next, in step S503, the driving mode determination unit 11a judges whether or not the vehicle can move to the destination in the selected driving mode (Yes in step S501).

For example, when the manual MT driving mode or the manual AT driving mode is allowed for the occupant, the driving mode determination unit 11a judges that the vehicle can move using the derived route (Yes in step S503). Even when the route includes the roads not allowed to run by automatic driving or the destination is not connected to a road allowed to run by automatic driving, it is considered that running by manual driving is possible. On the other hand, when the speed and route selecting automatic driving mode or the fully automatic driving mode is allowed, and when the derived route includes roads not allowed to run by automatic driving or the destination is not connected to the road allowed to run by automatic driving, the driving mode determination unit 11a judges that the vehicle cannot move to the destination in the selected driving mode (No in step S503). Thus, by determining the driving mode and determining the route based on the occupant's driver qualification information, driving based on the allowable driving mode for the vehicle to run on the route, is ensured. Specifically, when the driving mode is the speed and routs selecting automatic driving mode or the fully automatic driving mode, the route to the destination is determined based on the driver qualification information.

In step S505, driving mode determination unit 11a judges that the selected driving mode can be allowed (Yes in step S503).

Next, in step S313 (see FIG. 3), the driving mode determination unit 11a determines the driving mode selected by the occupant as the driving mode for the occupant to control the vehicle. The driving mode determination unit 11a causes the drive control device 60 to control the operation of the vehicle in the determined driving mode.

On the other hand, in step S507, the driving mode determination unit 11a judges that the selected driving mode cannot be allowed (No in step S501 or step S503).

Next, in step S315 (No in step S311), the driving mode determination unit 11a judges whether or not there is another allowable driving mode.

For example, in step S311, the occupant who has the regular car classification license (manual, no limitation) as the driver qualification information selects the speed and routs selecting automatic driving mode or the fully automatic driving mode, it is assumed that an alternative route is derived, to the destination including the roads not allowed to run by automatic driving. In this case, the driving mode determination unit 11a judges that there are the manual MT driving mode and the manual AT driving mode as the allowable driving modes for the occupant (Yes in step S315). This is because when the occupant has driver qualification information including the manual MT driving mode and the manual AT driving mode, it is considered that he/she can safely drive the vehicle to the destination by running on the alternate route by manual driving.

Further, in step S311, when it is assumed that the occupant who does not have a driver qualification as the driver qualification information selects the speed and the route selecting automatic driving mode, and the route is derived to the destination via only the road allowed to run by automatic driving, the driving mode determination unit 11a judges that there is the fully automatic driving mode as the allowable driving mode for the occupant (Yes in step S315). Only the operation of inputting the destination is allowed for the occupant who does not have a driver qualification, so that safe driving of the vehicle can be ensured.

Further, in step S311, when the occupant who does not have a driver qualification as the driver qualification information selects the manual MT driving mode or the manual AT driving mode, and when the route can be derived to the destination via only the roads allowed to run by automatic driving, the driving mode determination unit 11a judges that there is a fully automatic driving mode as the allowable driving mods for the occupant (Yes in step S315). Only the operation of inputting the destination is allowed for the occupant who does not have a driver qualification, so that safe driving of the vehicle can be ensured.

On the other hand, when there is no allowable driving mode as the driver qualification information possessed by the occupant, the driving mode determination unit 11a judges that there is no other allowable driving mode (No in step S315). For example, when the occupant who does not have a driver qualification as the driver qualification information selects the fully automatic driving mode, there is sometimes a case that it is impossible to derive the route to the destination via only the roads allowed to run by automatic driving.

In step S317, the driving mode determination unit 11a notifies the occupant of the allowable driving mode (Yes in step S315). For example, the driving mode determination unit 11a displays the allowable driving mode on the display unit 43 of the in-vehicle device 40, or outputs the allowable driving mode by voice using the sound output unit 45.

Next, in step S319, the allowable driving mode is input in the driving mode determination unit 11a by the occupant using the operation unit 44 of the in-vehicle device 40. When the notified allowable driving mode is not selected, the occupant who is seated in the driver's seat performs the operation of not selecting the allowable driving mode, using the operation unit 44 (No in step S319).

Next, in step S321, the driving mode determination unit 11a determines the driving mode input by the occupant as the driving mode for the occupant to control the vehicle. The driving mode determination unit 11a causes the drive control device 60 to control the operation of the vehicle in the determined driving mode.

On the other hand, in step S323, the driving mode determination unit 11a notifies the occupant that it is impossible to operate the vehicle (No in step S315 or S319). The driving mode determination unit 11a displays such that the vehicle cannot be driven, for example using the display unit 43 of the in-vehicle device 40, or outputs a voice accordingly, using the sound output unit 45.

The above is the description of the operation of determining the driving mode by the vehicle control device 10.

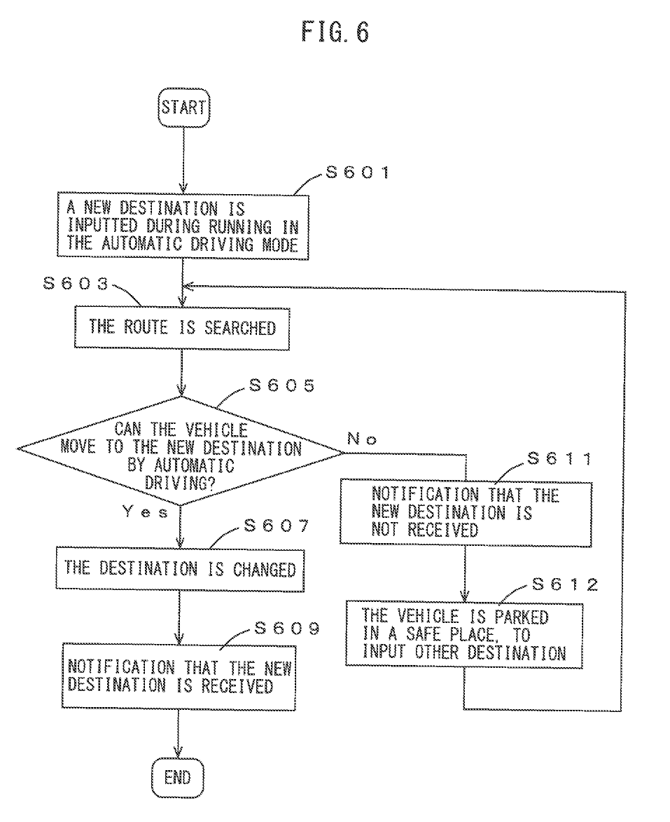

Next, the processing of the vehicle control device 10 when the occupant who is seated in the driver's seat changes the destination while the vehicle is running in the automatic driving mode, will be described hereafter with reference to FIG. 6.

First, in step S601, when the vehicle is running in the speed and route selecting automatic driving mode or in the fully automatic driving mode, the occupant who is seated in the driver's seat inputs a new destination using the operation unit 44 of the in-vehicle device 40. The occupant moving on the vehicle sometimes changes the destination for some reason. A new destination is input in the route determination unit 11b of the processing unit 11 of the vehicle control device 10 using the in-vehicle device 40.

Next, in stop S603, the route determination unit 11b attempts to derive the route from the current position of the vehicle to the new destination via only the road allowed to run by automatic driving, using the in-vehicle device 40. The route determination unit 11b judges that the route cannot be derived when it is impossible to derive the route via only the road allowed to run by automatic driving.

Next, in step S605, the route determination unit 11b judges whether or not the vehicle can move to the new destination by automatic driving. In step S603, when the route can be derived via only the road allowed to run by automatic driving, the route determination unit 11b judges that the vehicle can move to the new destination by automatic driving (Yes in step S605). On the other hand, otherwise, the route determination unit 11b judges that the vehicle cannot move to the new destination by automatic driving (No in step S605)

Next, in step S607, the route determination unit 11b changes the destination of the route to the new destination.

Next, in step S609, the route determination unit 11b notifies the occupant that the new destination has been accepted by using the display unit 43 or the sound output unit 45 of the in-vehicle device 40.

On the other hand, in step S611, the route determination unit 11b notifies the occupant that the new destination is not accepted by using the display unit 43 or the sound output unit 45 of the in-vehicle device 40 (No in step S605).

Next, in step S612, the route determination unit 11b notifies the occupant who is seated in the driver's seat and parks the vehicle in a safe place, to input other destination, using the display unit 43 or the sound output unit 45 of the in-vehicle device 40. Another destination desired by the occupant who is seated in the driver's seat is input in the route determination unit 11b, using the operation unit 44 of the in-vehicle device 40. Then, processing is returned to step S603. A parking lot registered in map data stored in the storage unit 52 of the in-vehicle device 40 and connected to the route to the current destination, a facility such as a store having a parking lot, or a parking lot located around the current destination, and the like can be given for example as safe places.

The above is the description of the processing of the vehicle control device 10 when the occupant who is seated in the driver's seat changes the destination while the vehicle is running in the automatic driving mode.

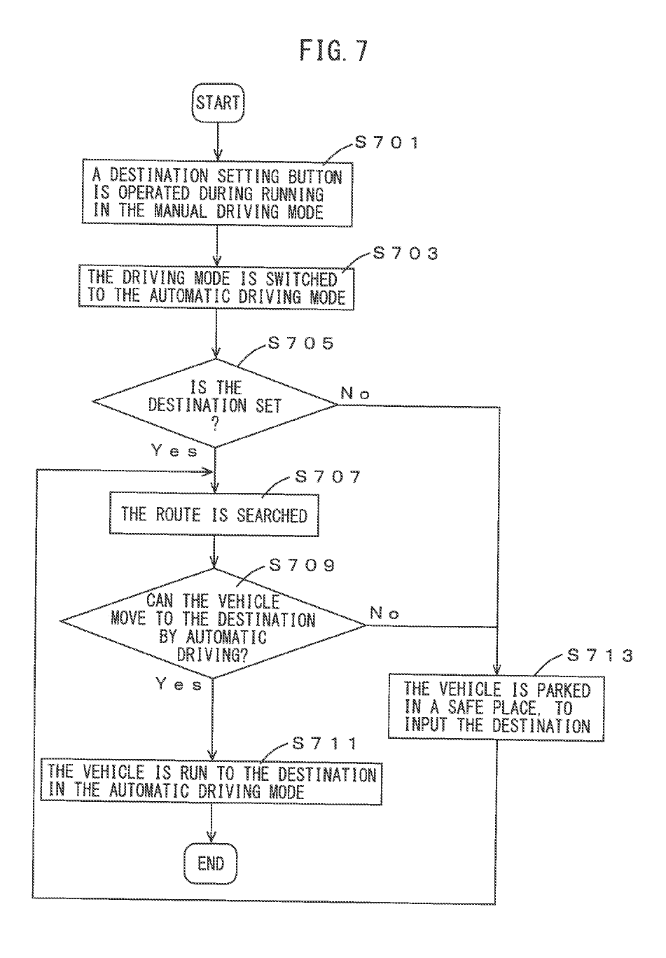

Next, the processing of the vehicle control device 10 when the occupant who is seated in the driver's seat switches the driving mode to the automatic driving mode while the vehicle is running in the manual driving mode, will be described hereafter, with reference to FIG. 7.

First, in step S701, in the vehicle running in the manual MT driving mode or the manual AT driving mode, the occupant who is seated in the driver's seat operates a destination setting button (not illustrated) displayed on the display unit 43 by using the operation unit 44 of the in-vehicle device 40.

Next, in step S703, the driving mode determination unit 11a of the processing unit II of the vehicle control device 10 switches the driving mode of the vehicle to the fully automatic driving mode, when the operation information is input for setting the destination by operating a destination setting button.

Next, in step S705, the route determination unit 11b judges whether or not the destination is set. In the manual MT driving mode or the manual AT driving mode, when the destination is set in the in-vehicle device 40, the route determination unit 11b judges that the destination is set (Yes in step S705). On the other hand, in the manual MT driving mode or the manual AT driving mode, when the destination is not set in the in-vehicle device 40, the route determination unit 11b judges that the destination is not set (No in step S705). When it is judged that the destination is not set, the route determination unit 11b may perform the following processing after the abovementioned safe place is set as a provisional destination.

Next, in step S707, the route determination unit 11b attempts to derive the route from the current position of the vehicle to the destination at the present time via only the road allowed to run by automatic driving (Yes in step S705). When it is impossible to derive the route via only the road allowed to run by automatic driving, the route determination unit 11b judges that it is impossible to derive the route, using in-vehicle device 40.

Next, in step S709, the route determination unit 11b determines whether or not the vehicle can move to the current destination by automatic driving. When the route can be derived via only the road allowed to run by automatic driving in step S707, the route determination unit 11b judges that the vehicle can move to the current destination by automatic driving (Yes in step S709). On the other hand, otherwise, the route determination unit 11b judges that the vehicle cannot move to the current destination by automatic driving (No in step S709).

Next, in step S711, the driving mode determination unit 11a controls the operation of the vehicle in the automatic driving mode using the drive control device 60, so that the vehicle can run to the destination.

On the other hand, in step S713 (No in step S705 or S709), the route determination unit 11b notifies the occupant who is seated in the driver's seat and parks the vehicle in a safe place, to input the destination, using the display unit 43 or the sound output unit 45 of the in-vehicle device 40. The destination desired by the occupant who is seated in the driver's seat is input in the route determination unit 11b by the occupant, using the operation unit 44 of the in-vehicle device 40. Then, processing is returned to step S707.

The above is the description of the operation of the vehicle control device 10 when the occupant who is seated in the driver's seat switches the driving mode to the automatic driving mode while the vehicle is running in the manual driving mode.

According to the abovementioned system 1 of this embodiment, the operation range for allowing the operation of the vehicle having the automatic driving mode, is automatically determined based on the occupant's driver qualification information. Accordingly, the vehicle can be safely driven based on the occupant's driver qualification information.

Further, according to the system 1, in the manual driving mode, the operation range for operating the vehicle, is automatically determined based on the driver qualification information possessed by the occupant who is seated in the driver's seat, and therefore safe running of the vehicle is ensured within a range corresponding to the skill of the occupant.

Further, according to the system 1, the operation other than the operation of inputting the destination is not allowed for the occupant who does not have a driver qualification as the driver qualification information, and therefore running of the vehicle in the automatic driving mode can be ensured by preventing the occupant's manual operation.

In the present invention, the vehicle control system, the vehicle control device and the vehicle control method of the abovementioned embodiments can be appropriately modified without departing from the gist of the present invention.

For example, in the abovementioned embodiment, the route is derived by the in-vehicle device 40 under control of the vehicle control device 10. However, the route may also be derived by the vehicle control device 10.

Further, when the image transmitted from the fingerprint sensor 33 matches the image of a previously registered fingerprint, the driving mode determination unit 11a of the processing unit 11 of the vehicle control device 10, may allow the automatic driving mode for the occupant to perform automatic driving based on previously registered automatic driving information (time zone and route etc.). The fully automatic driving mode based on the automatic driving information (time zone, route, etc.) is registered in the storage unit 12, as the driver qualification information in association with the image of the fingerprint which is the occupant's personal information and registered in advance. In this fully automatic driving mode, the vehicle is controlled so as to move on a predetermined route in a predetermined time zone. Such setting can be used, for example, when a vehicle is used to pick up and drop children at school in the morning and evening.

There is a possibility that the type of license and driver qualification are sometimes changed due to future revisions of traffic rules or the like. For example, an “automatic driver's license” may be created, which requires certain knowledge in traffic rules or like even if driving operation cannot be performed, and in such a case, even in a case of the fully automatic driving, there is a possibility that running is not allowed unless some qualified driving person is on board. Accordingly, the vehicle control device 10 according to the modified example can update the license information reference table 12b stored in the storage unit 12 so as to cope with such revision of the traffic rules or the like. Specifically, the user may input the type of license/driver qualification information added or changed by revision, using an input unit not illustrated, or it may be read from an information medium (CD-ROM, USB memory, etc.) by a read unit (not illustrated), or it may be acquired from a server outside the vehicle by a wireless communication unit (not illustrated). Thus, even if the traffic rules are changed in the future, the operation range can be appropriately determined for allowing the operation of the vehicle having the automatic driving mode, based on the occupant's driver qualification information.

Next, a preferred embodiment of a vehicle control network system disclosed in this specification will be described with reference to the drawings. However, the technical scope of the present invention is not limited to those embodiments, but extends to the invention described in the claims and equivalents thereof.

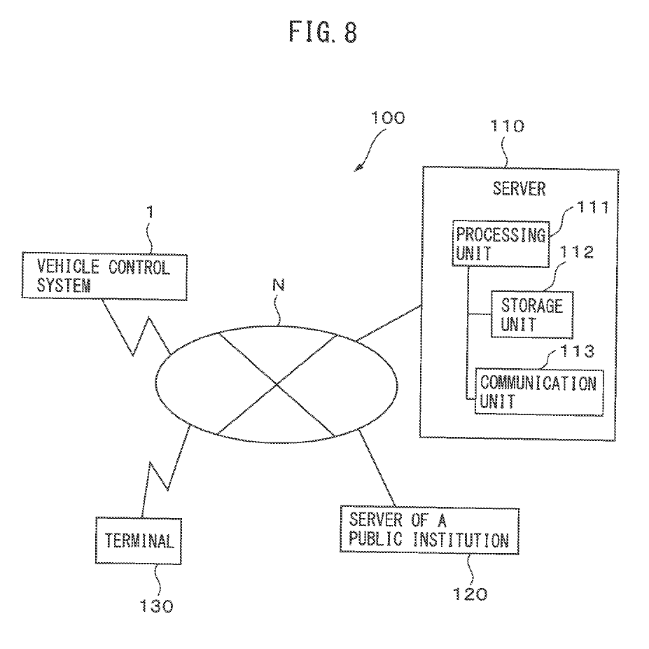

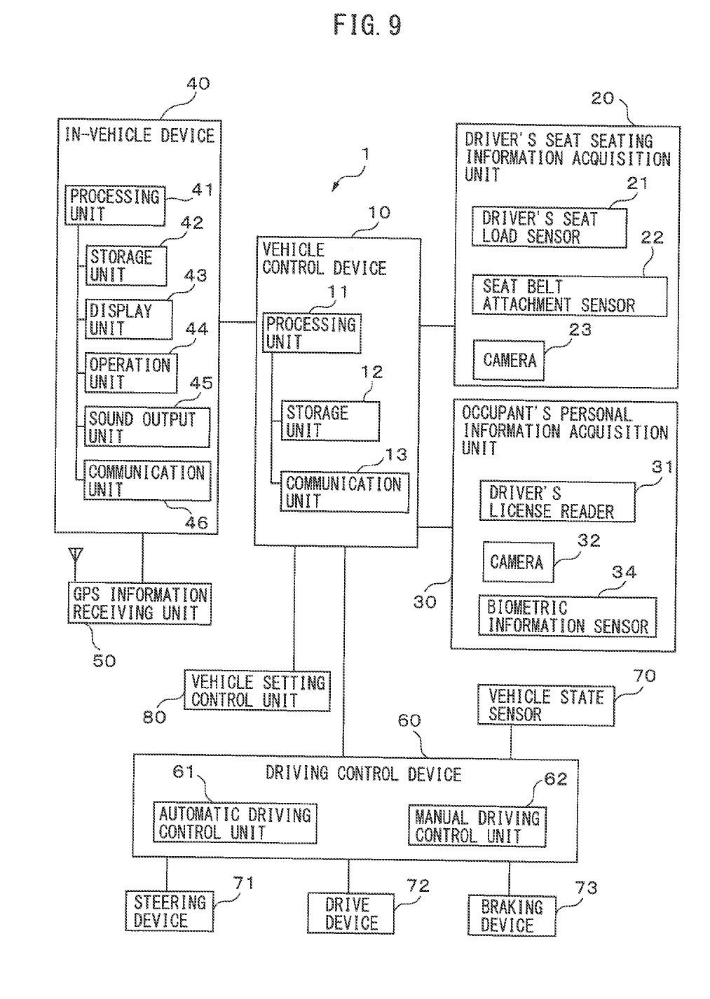

FIG. 8 is a diagram illustrating a vehicle control network system according to an embodiment of the present disclosure. FIG. 9 is a diagram illustrating a vehicle control system included in the vehicle control network system according to an embodiment of the present disclosure.

The vehicle control network system 100 (hereinafter simply referred to as the system 100) of this embodiment, includes a vehicle control system 1 (also simply referred to as a system 1 hereafter), and a server 110 communicably connected to the system 1 via the network N, according to a second embodiment of the present disclosure.

The system 1 controls the operation of the vehicle having the automatic driving mode driven automatically without occupant's driving operation, and the manual driving mode driven by occupant's driving operation. In this embodiment, the system 1 is installed in a vehicle having four wheels.

In the automatic driving mode, the operation of a main control system including steering, acceleration, and braking of the vehicle is automatically performed. In the manual driving mode, the operation of the abovementioned main control system of the vehicle is performed by the occupant who is seated in the driver's seat.

The operation range for allowing the operation of the vehicle is different between the automatic driving mode and the manual driving mode thereby driving the vehicle by the occupant. For example, in the automatic driving mode, the occupant is allowed to operate input of the destination, but is not allowed to operate the main control system including steering, acceleration and braking of the vehicle. On the other hand, in the manual driving mode, the occupant is allowed to operate the main control system.

In the system 1, the driving mode is determined based on the driver qualification information acquired from the server 110, which is possessed by the occupant who is seated in the driver's seat of the vehicle. The vehicle can be controlled by the determined driving mode.

The system 1 may be operated by the occupant who is seated in the driver's seat of the vehicle or may be operated by communication from the occupant who is outside the vehicle.

The server 110 has a storage unit 112 for storing a driver qualification information table in which the driver qualification information associated with the occupant's personal information possessed by the occupant who is seated in the driver's seat is registered.

The server 110 may communicate with a server 120 of a public institution such as a police or a public safety community in a communicable manner via the network N. The server 110 acquires the driver qualification information possessed by the occupant who is seated in the driver's seat and the driver qualification-related information associated with the driver qualification information, from the server 120 of the public institution, and updates the driver qualification related information. For example, when the driver's license has expired, the server 110 updates the information as follows: the occupant is not qualified for driving as the driver qualification information.

Further, the system 1 acquires from the server 110, vehicle setting information, route history information, and automatic driving history information associated with the occupant's personal information possessed by the occupant who is seated in the driver's seat of the vehicle, and controls the vehicle based on these information. The vehicle setting information, the route history information and the automatic driving history information will be described later.

In the system 1, based on the vehicle setting information, the route history information and the automatic driving history information, each vehicle is controlled so as to correspond to the occupant based on the occupant's personal information, even when the same occupant boards a different vehicle. Further, in a system 100, based on the vehicle setting information, the route history information and the automatic driving history information, the same vehicle is controlled so as to correspond to each occupant based on each occupant's personal information, even when a different occupant boards the same vehicle.

The system 1 is connected to a terminal 130 such as an advanced function mobile terminal possessed by the occupant who is seated in the driver's seat in a communicable manner via the network N. The occupant who is seated in the driver's seat can communicate with the system 1 from the outside the vehicle using the terminal 130.

Next, the system 1 will be described in detail.

The system 1 includes a vehicle control device 10, a driver's seat seating information acquisition unit 20, an occupant's personal information acquisition unit 30, and an in-vehicle device 40. Further, the system 1 includes a drive control device 60, a vehicle state sensor 70, and a vehicle setting control unit 80.

Next, the vehicle control device 10 will be described in detail hereafter.

The vehicle control device 10 detects that the occupant is seated in the driver's seat based on the information acquired by the driver's seat seating information acquisition unit 20. Further, the vehicle control device 10 transmits the occupant's personal information acquired by the occupant's personal information acquisition unit 30 to the server 110 via the network N, and receives the driver qualification information associated with the occupant's personal information from the server 110.

Based on the received driver qualification information, the vehicle control device 10 determines the allowable driving mode for the occupant (the occupant operating the vehicle) who is seated in the driver's seat.

The destination is input in the vehicle control device 10 using the in-vehicle device 40, and the route allowed to run by the allowable driving mode from the current position to the destination is searched.

The vehicle control device 10 causes the drive control device 60 to control the operation of the vehicle.

Further, the vehicle control device 10 causes the vehicle setting control unit 80 to adjust a drive position so as to correspond to the occupant, based on the occupant's vehicle setting information, and control the in-vehicle device 40.

The vehicle control device 10 includes the processing unit 11 the storage unit 12, and the communication unit 13.

The processing unit 11 includes one or a plurality of processors and peripheral circuits. The processing unit 11 performs control of various hardware components of the vehicle control device 10 and various processing, in accordance with a predetermined program 12a previously stored in the storage unit 12 which is used for temporarily storing data generated during processing.

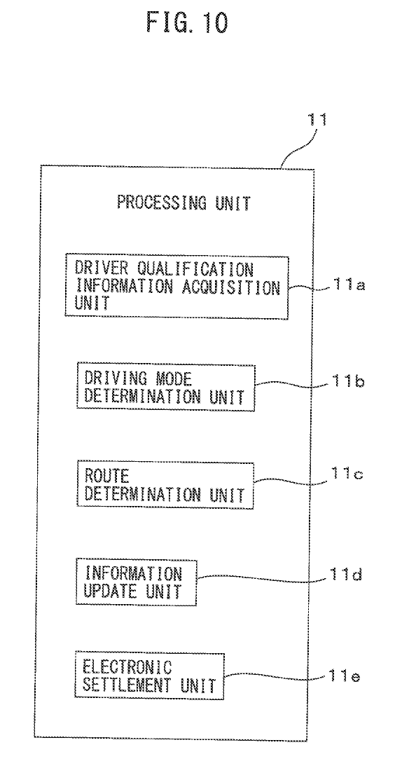

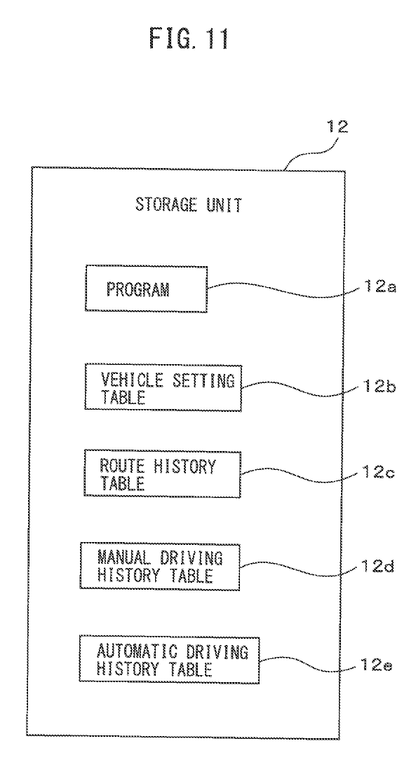

FIG. 10 is a functional block diagram of a processing unit of the vehicle control device. FIG. 11 is a diagram for explaining the storage unit.

The processing unit 11 incudes the driver qualification information acquisition unit 11a, the driving mode determination unit 11b, the route determination unit 11c, an information updating unit 11d, and an electronic settlement unit 11e.

These units of the processing unit 11 are, for example, function modules realized by a computer program operating on a processor of the processing unit 11. Each unit of the processing unit 11 may be installed in the vehicle control device 10 as a separate circuit, respectively. Each unit will be described later.

The storage unit 12 may have a semiconductor memory such as a random access memory (RAM) or a read only memory (ROM), or a magnetic disk or a flash memory. The storage unit 12 may have a drive capable of reading out a predetermined program 12a from a storage medium that stores the program 12a.

The storage unit 12 stores the predetermined program 12a, the vehicle setting table 12b, the route history table 12c, a manual driving history table 12d, an automatic driving history table 12e, and the like. The vehicle setting table 12b, the route history table 12c, the manual driving history table 12d, and the automatic driving history table 12e will be described later.

The communication unit 13 transmits and receives information to and from the server 110 via the network N using wireless communication. The communication unit 13 is connected to the network N via a base station, for example, in accordance with a predetermined communication standard such as 3GPP (Third Generation Partnership Project) or LTE (Long Term Evolution). Further, the communication unit 13 transmits and receives information to and from the driver's seat seating information acquisition unit 20, the occupant's personal information acquisition unit 30, the in-vehicle device 40, the driving control device 60, and the vehicle setting control unit 80. The processing unit 11 performs various processing based on the information received using the communication unit 13. Further, the processing unit 11 transmits the results of various processing using the communication unit 13. The communication unit 13 may have a communication circuit and a communication line or an antenna that performs transmission and reception.

Further, the communication unit 13 is capable of carrying out wireless communication with a wireless communication device disposed at a toll gate of a toll road. Further, the communication unit 13 is capable of carrying out wireless communication with the terminal 130 of the occupant.

The explanation for the driver's seat seating information acquisition unit in the vehicle control system of the first embodiment is applied as appropriate, to the explanation for the driver's seat seating information acquisition unit 20.

Next, the occupant's personal information acquisition unit 30 will be described hereafter in detail.

The occupant's personal information acquisition unit 30 acquires occupant's personal information for recognizing the occupant who is seated in the driver's seat of the vehicle and transmits the acquired occupant's personal information to the vehicle control device 10. The occupant's personal information is used in the server 110 to determine the driver qualification information possessed by the occupant. Examples of the occupant's personal information include information held by the driver's license, an image of an occupant's face, biometric information possessed by the occupant, and the like. Specifically, the occupant's personal information acquisition unit 30 includes a driver's license reader 31, a camera 32, and a biometric information sensor 34. However, the occupant's personal information acquisition unit 30 may not be required to have all of these sensors and the like. Further, the occupant's personal information acquisition unit 30 may have other means for acquiring the occupant's personal information.

The driver's license reader 31 acquires the information held by the IC card type driver's license of the occupant who is seated in the driver's seat of the vehicle, and transmits the acquired information to the vehicle control device 10 as the occupant's personal information. The driver's license reader 31 is disposed, for example, below a dashboard in front of the driver's seat of the vehicle. The occupant who is seated in the driver's seat of the vehicle holds the carried IC card type driver's license close to the driver's license reader 31 or, making it contact with the driver's license reader 31, to thereby make it read the information held by the driver's license. For example, an RFID reader can be used as the driver's license reader 31. The information held by the driver's license includes the license number and birth date.

The camera 23 captures an image including the driver's seat of the vehicle and transmits the captured image to the vehicle control device 10 as the occupant's personal information. The camera 32 may be the same as the camera 23.

The biometric information sensor 34 acquires the biometric information possessed by the occupant who is seated in the driver's seat of the vehicle, and transmits the acquired biometric information to the vehicle control device 10 as the occupant's personal information. Examples of the biometric information include an image of a fingerprint, a voice print, a vein pattern, and the like. When the image of the fingerprint is used as the biometric information, for example, a capacitance type biometric information sensor can be used as the biometric information sensor 34. The occupant who is seated in the driver's seat of the vehicle causes the biometric information sensor 34, which is a fingerprint sensor, to read the fingerprint, for example.

Next, the in-vehicle device 40 will be described in detail hereafter.

The in-vehicle device 40 includes the processing unit 41, the storage unit 42, the display unit 43, the operation unit 44, the sound output unit 45, and the communication unit 46. The in-vehicle device 40 is operable under the control of the vehicle control device 10. The explanation for the in-vehicle device in the vehicle control system of the first embodiment is applied as appropriate, to the explanation for the processing unit 41, the storage unit 42, the display unit 43, the operation unit 44, and the sound output unit 45.

The vehicle control device 10 acquires vehicle setting information from the server 110, the vehicle setting information including information regarding occupant's setting of the in-vehicle device 40 such as the sound output unit 45, and notifies the in-vehicle device 40 of the acquired vehicle setting information. The in-vehicle device 40 adjusts the setting of the sound output such as an equalizer function of the sound output unit 45 based on the notified vehicle setting information.

Thus, even when the same occupant boards a different vehicle, the setting of the sound output of each vehicle is adjusted so as to correspond to the occupant, based on the occupant's vehicle setting information. Further, even when a different occupant boards the same vehicle, the setting of the sound output of the same vehicle is adjusted so as to correspond to each occupant, based on each occupant's vehicle setting information.

The communication unit 46 communicates with the vehicle control device 10 and the in-vehicle network (compliant with the controller area network (CAN)) installed in the vehicle. Further, the communication unit 46 may be capable of communicating with the outside via the network N using wireless communication. The communication unit 46 may include a communication circuit and a communication line or an antenna that performs transmission and reception. In addition, the communication unit 46 may be used together with the communication unit 13.

The explanation for the drive control device in the vehicle control system of the first embodiment is applied as appropriate, to the explanation for the driving control device 60.

Next, the vehicle setting control unit 80 will be described in detail hereafter.

The vehicle setting control unit 80 is controlled by the vehicle control device 10 to drive a position adjustment drive unit (not illustrated) that drives a seat, a steering wheel, a rearview mirror, and the like (not illustrated), and control driving positions of the seat, steering wheel, rearview mirror, and the like.

The vehicle control device 10 acquires vehicle setting information from the server 110, the vehicle setting information including information regarding an occupant's driving position, and notifies the vehicle setting control unit 80 of the acquired vehicle setting information. Based on the notified vehicle setting information, the vehicle setting control unit 80 adjusts the position of the seat, the steering wheel, the room mirror, and the like (not illustrated) using a position adjustment drive unit (not illustrated).

Thus, even when the same occupant boards a different vehicle, the driving position of each vehicle is adjusted so as to correspond to the occupant, based on the information regarding setting of the vehicle by the occupant. Further, even when a different occupant boards the same vehicle, the driving position of the same vehicle is adjusted so as to correspond to each occupant, based on the information regarding setting of the vehicle by the each occupant.

Next, the server 110 will be described hereafter.

The server 110 includes a processing unit 111, a storage unit 112, and a communication unit 113.

The processing unit 111 includes one or more processors and peripheral circuits. The processing unit 111 performs control of each hardware component of the server 110 and various processing in accordance with a predetermined program previously stored in the storage unit 112 which is used for temporarily storing data generated during processing. There is no need for a single server. The operation of the server may be realized by a plurality of servers in cooperation, which are connected in a communicable manner via the network N.

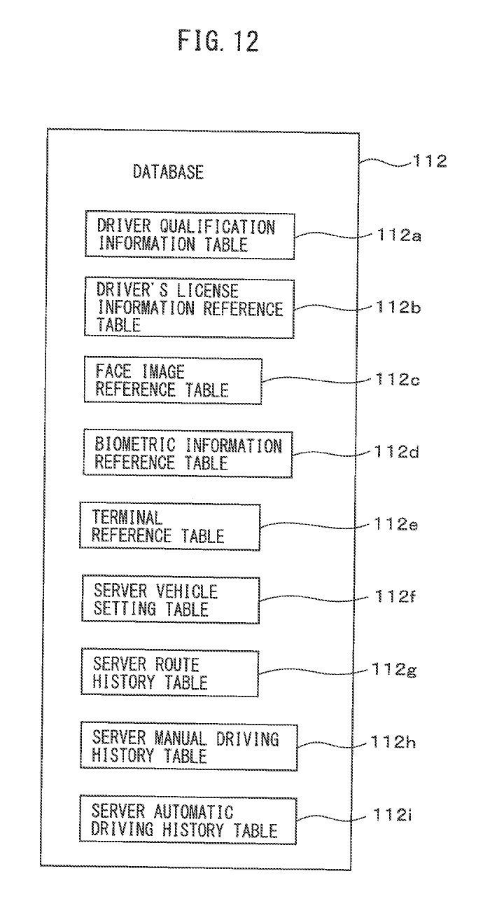

The server 110 manages the driver qualification information possessed by the occupant who is seated in the driver's seat of the vehicle. The driver qualification information is the information used by the vehicle control device 10 to determine the allowable driving mode for the occupant. The information such as driver qualification information possessed by the occupant and the like is stored in the storage unit 112. FIG. 12 is a diagram for explaining the storage unit 112.

The storage unit 112 may have a semiconductor memory such as a random access memory (RAM) or a read only memory (ROM), or a nonvolatile memory such as a magnetic disk or a flash memory. Further, the storage unit 112 may use a disk drive as a drive capable of reading out a predetermined program stored in a non-transitory storage medium. The storage unit 112 stores a driver qualification information table 112a, a license information reference table 112b, a face image reference table 112c, a biometric information reference table 112d, a terminal reference table 112e, a server vehicle setting table 112f, a server route history table 112g, a server manual driving history table 112h, and a server automatic driving history table 112i.

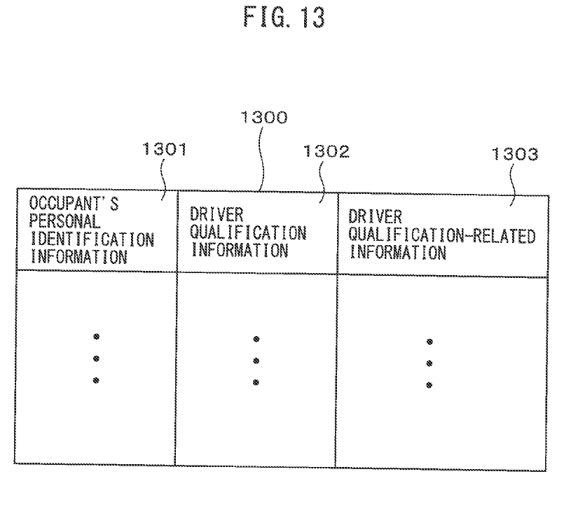

The occupant's personal identification information for identifying the occupant who is seated in the driver's seat of the vehicle and the occupant's driver qualification information are registered in the driver qualification information table 112a, in association with each other. FIG. 13 is a diagram illustrating the driver qualification information table. The driver qualification information table 1300 includes an occupant's personal identification information field 1301 in which the occupant's personal identification information is registered, a driver qualification information field 1302 in which the occupant's driver qualification information is registered, and a driver qualification-related information field 1303 in which occupant's driver qualification-related information is registered.

The server 110 acquires the occupant's personal identification information registered in the occupant's personal identification information field 1301, based on the occupant's personal information transmitted from the vehicle control device 10, with reference to the license information reference table 112b or the face image reference table 112c or the biometric information reference table 112d or the terminal reference table 112e.

The driver qualification information associated with the occupant's personal identification information is registered in the driver qualification information field 1302. Examples of the driver qualification information registered in the driver qualification information field 1302 includes: a regular car classification license (manual, no limitation), a regular car classification license (limited to automatic), and a regular motorcycle license etc. Thus, the driver qualification information possessed by the occupant who is seated in the driver's seat of the vehicle, is registered in the driver qualification information table 1300, based on the driver qualification registered in the driver's license which is an official certificate. Further, not having the driver's license is registered in the driver qualification information field 1302 regarding the occupant who is seated in the driver's seat of the vehicle and not having the driver's license, in other words, who does not have a driver qualification.

The communication unit 113 transmits and receives information to and from the vehicle control device 10 and the public server 120 via the network N. The processing unit 111 performs various processing based on the information received using the communication unit 113. Further, the processing unit 111 transmits the result of performing various processing using the communication unit 113. The communication unit 113 may have a communication circuit and a communication line or an antenna that performs transmission and reception.

The server 110 acquires information regarding validity and revocation of the driver's license associated with the driver's license number, from the server 120 of the public institution via the network N, and may update the driver qualification information in the driver qualification information field 1302, with reference to the license information reference table 112b. For example, when the driver's license has expired, the driver qualification information is updated as follows: the occupant is not qualified for driving as the driver qualification information.

The driver qualification-related information registered in the driver qualification-related information field 1303 includes, for example, invalid information indicating that the driver qualification is invalid due to a reason such as whether or not the driver's license is suspended. Further, the occupant's driver qualification-related information includes invalid information indicating that the driver qualification is invalid due to a reason that the driver's license associated with the personal identification information is stolen or the like. Further the driver qualification-related information includes invalid information indicating that the driver qualification is invalid due to a reason such as a forged driver license associated with the occupant's personal identification information. The server 110 may acquire the driver qualification-related information from the server 120 of the public institution via the network N. When the occupant's driver qualification-related information includes the invalid information, the server 110 judges that the occupant does not have the driver qualification as the driver qualification information irrespective of the information registered in the driver qualification information field 1302.

The information held by the driver's license and the occupant's personal identification information are registered in the license information reference table 112b, in association with each other. The driver's license number may be used as the information held by the driver's license. Further, as the information held by the driver's license, the birth date may be used together with the driver's license number.

The image of the occupant's face and the occupant's personal identification information are registered in the face image reference table 112c, in association with each other.

The occupant's biometric information and the occupant's personal identification information are registered in the biometric information reference table 112d, in association with each other. Examples of the occupant's biometric information includes an image of a fingerprint, a voice print, a vein pattern, and the like.

Terminal identification information for identifying the terminal 130 possessed by the occupant and the occupant's personal identification information are registered in the terminal reference table 112e, in association with each other.

Vehicle setting information such as setting information and driving position information of the in-vehicle device 40 and the occupant's personal identification information are registered in the server vehicle setting table 112f, in association with each other.

The route history information such as roads the occupant used in the past, facilities the occupant parked in the past, the driving time the occupant occasionally ran in the past, and the occupant's personal identification information are registered in the server route history table 112h, in association with each other. Examples of the roads the occupant used in the past include the roads (toll roads, general roads, etc.) selected by the occupant so as to be included in the route to the destination. The system 1 may include a road used by the occupant in the past when deriving the route to the destination. Examples of the facility the occupant parked in the past, include a commercial facility such as a convenience store. The system 1 may notify the occupant of a proposal to utilize the facility when deriving the route to the destination, in a case that the facility the occupant parked in the past is connected to the route. The system 1 may also notify the occupant of a proposal to park the vehicle and take a rest, based on the driving time the occupant continuously ran in the past.

The manual driving information when the occupant drove the vehicle in the manual driving mode in the past, and the occupant's personal identification information are registered in the server manual driving history table 112h, in association with each other. Examples of the manual driving information include operational characteristics such as vehicle speed, braking, acceleration, inter-vehicle distance, lane switching, overtaking, horn braking, and the like. The occupant's manual driving information is used as control information for controlling the vehicle running in the automatic driving mode. For example, the vehicle control device 10 may create an automatic driving pattern such as an eco-pattern for running while suppressing fuel consumption, a time pattern for reducing the arrival time to the destination, and a safe pattern for particularly safe driving, based on the occupant's manual driving information, and may control the driving control device 60 based on these patterns.

Automatic driving evaluation information fed back to the system 1 when the occupant boards the vehicle in the past in the automatic driving mode, and the occupant's personal identification information are registered in the automatic server driving history table 112j, in association with each other. Examples of the automatic driving evaluation information, include characteristics of vehicle speed, braking, acceleration, inter-vehicle distance, lane change, overtaking, and horn braking. The occupant's automatic driving evaluation information is used as control information for controlling the vehicle running in the automatic driving mode.

The vehicle control device 10 in the system 1 has the manual MT driving mode, the manual AT driving mode, the speed and route selecting automatic driving mode, and the fully automatic driving mode, as the allowable driving modes of the vehicle in which it is installed.

The manual MT driving mode is one of the manual driving modes. The manual MT driving mode is the driving mode for manually driving the vehicle by manually operating a gear change by the occupant by operating a shift lever and a clutch pedal (not illustrated). The manual MT driving mode is a so-called driving mode of a manual vehicle.

The manual AT driving mode is another one of the manual driving modes. The manual AT driving mode is the driving mode for manually driving the vehicle by the occupant, with the gear change operation controlled by the manual driving control unit 62. The manual AT driving mode is a so-called automatic vehicle driving mode.

The speed and route selecting automatic driving mode is one of the automatic driving modes. The speed and route selecting automatic driving mode is the driving mode for automatically driving the vehicle in which the occupant is allowed to select the destination, the route, and the speed setting operation. The speed selection means to specify the speed at which the vehicle runs within a range of a speed limit or less. Route selection means to derive the route so as to go through a point or a road designated by the occupant when deriving the route.

The fully automatic driving mode is another one of the automatic driving modes. The fully automatic driving mode is the driving mode for automatically driving the vehicle, in which only the operation of setting the destination is allowed for the occupant.

In a case of the regular car classification license (manual, no limitation) as the driver qualification information, all of the abovementioned four manual MT driving mode, the manual AT driving mode, the speed and route selecting automatic driving mode, and the fully automatic driving mode are allowed for the occupant, as the driving modes.

In a case of the regular oar classification license (limited to automatic) as the driver qualification information, the manual AT driving mode, the speed and the route selecting automatic driving mode, and the fully automatic driving mode are allowed for the occupant as the driving modes, among the abovementioned four driving modes.

In a case of the regular motorcycle license as the driver qualification information, the speed and route selecting automatic driving mode and the fully automatic driving mode are allowed for the occupant as the driving modes, among the abovementioned four driving modes. The occupant who has the regular motorcycle license is considered to grasp traffic restrictions such as that there is a speed limit for running on a road and that on a one-way road can only run in a predetermined direction. Therefore, operation of the speed and route selection is allowed for the occupant. However, in a case of the regular motorcycle license, manual driving of vehicles with four wheels is not allowed, and therefore the manual driving mode is not allowed for the occupant.

Next, the operation of the abovementioned system 100 will be hereafter below with reference to the drawings.

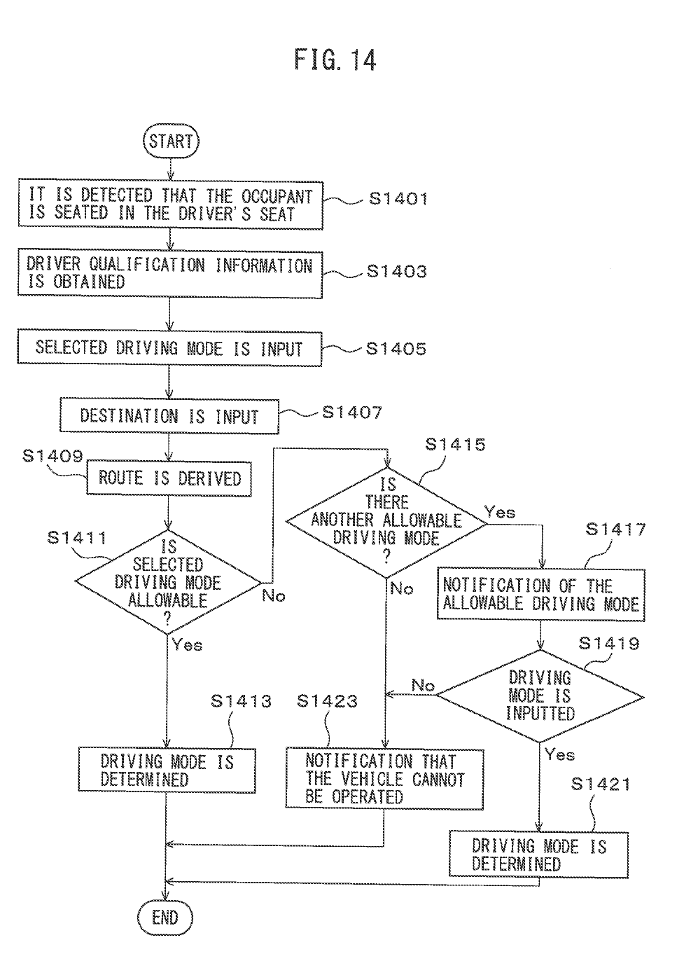

FIG. 14 is a flowchart for explaining the processing of determining the driving mode by the vehicle control device 10.

First, in step S1401, the driver qualification information acquisition unit 11a of the processing unit 11 of the vehicle control device 10 detects that the occupant is seated in the driver's seat of the vehicle, based on the information from the driving seat occupancy information acquisition unit 20.

The driver qualification information acquisition unit 11a may detect that the occupant is seated in the driver's seat of the vehicle, based on the signal transmitted from the driver's seat load sensor 21.

Further, the driver qualification information acquisition unit 11a may detect that the occupant is seated in the driver's seat of the vehicle, based on the signal transmitted from the seat belt attachment sensor 22.

Further, the driver qualification information acquisition unit 11a may detect that the occupant is seated in the driver's seat of the vehicle, based on the image transmitted from the camera 23. For example, the driver qualification information acquisition unit 11a may analyze the image using an identifier of a support vector machine or adaBoost, and may detect the occupant who is seated in the driver's seat of the vehicle.

When detecting that the occupant is seated in the driver's seat of the vehicle, the driver qualification information acquisition unit 11a may use one or more of the means for acquiring the abovementioned plurality of seating information. When multiple means are used, seating of the occupant may be detected using a majority voting method.

Next, in step S1403, the driver qualification information acquisition unit 11a which detects that the occupant is seated in the driver's seat of the vehicle, transmits the occupant's personal information acquired by the occupant's personal information acquisition unit 30 to the server 110 via the network N. Then, the driver qualification information acquisition unit 11a acquires the occupant's driver qualification information transmitted from the server 110.

The driver qualification information acquisition unit 11a may transmit the terminal identification information of the terminal 130 possessed by the occupant as the occupant's personal information, to the server 110 via the network N. This is because for example, there is sometimes a case that the occupant who is seated in the driver's seat of the vehicle is outside the vehicle and communicates with the communication unit 13 of the vehicle control device 10 using the terminal 130. In this case, the driver qualification information acquisition unit 11a acquires the terminal identification information from the terminal 130.

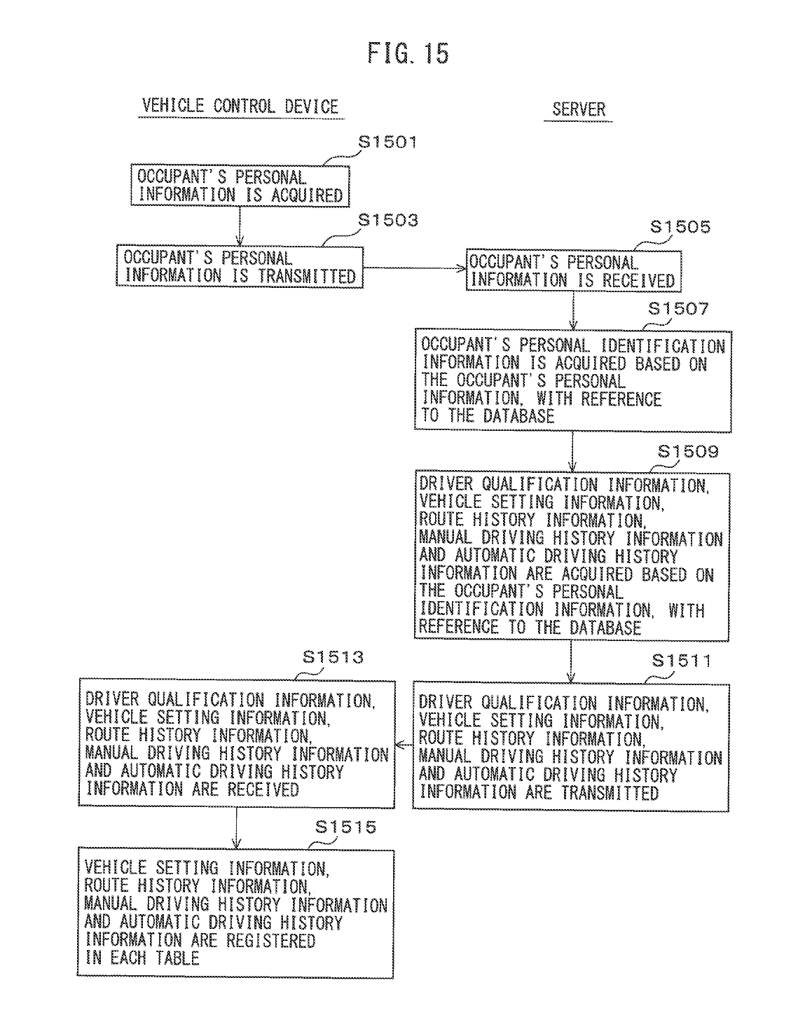

The processing of step S1403 will be described hereafter, with reference to FIG. 15.

First, in step S1501, the driver qualification information acquisition unit 11a of the processing unit 11 of the vehicle control device 10 receives the occupant's personal information acquired by the occupant's personal information acquisition unit 30. The driver qualification information acquisition unit 11a may acquire one or a plurality of the information held by the driver's license, an image of a face of the occupant who is seated in the driver's seat of the vehicle, the biometric information and the terminal identification information possessed by the occupant who is seated in the driver's seat of the vehicle, as the occupant's personal information.

When the information cannot be acquired from the driver's license by the driver's license reader 31 within a predetermined time after detecting that the occupant is seated in the driver's seat of the vehicle, the driver qualification information acquisition unit 11a judges that the occupant does not have a driver's license.

Next, in step S1503, the driver qualification information acquisition unit 11a transmits the occupant's personal information to the server 110 via the network N.

Next, in step S1505, the server 110 receives the occupant's personal information.

Next, in step S1507, the server 110 acquires the driver qualification information possessed by the occupant who is seated in the driver's seat of the vehicle, based on the received occupant's personal information, with reference to the storage unit 112.

Specifically, based on the received occupant's personal information, first, the server 110 acquires the occupant's personal identification information associated with the occupant's personal information, and next, based on the occupant's personal identification information, the server 110 acquires the driver qualification information associated with the occupant's personal identification information.

When the information held by the driver's license and acquired using the driver's license reader 31 is received as the occupant's personal information, the occupant's personal identification information is acquired, with reference to the license information reference table 112b stored in the storage unit 112. For example, the server 110 acquires the occupant's personal identification information associated with the driver's license number matching the occupant's personal information, with reference to the license information reference table 112b.

When the driver qualification information cannot be acquired with reference to the license information reference table 112b, the server 110 judges that the occupant does not have a driver qualification as the driver qualification information. This is because the information held by the driver's license is not registered in the license information reference table 112b in some cases.

Further, the server 110 may determine the driver qualification information based on the driver qualification of the driver's license and the occupant's age which are the occupant's personal information held by the driver's license. For example, when the occupant's age is equal to or more than a predetermined age, the driver qualification information allowed for the occupant may be limited to only the speed and route selecting automatic driving mode or the fully automatic driving mode, even if the occupant has the regular car classification license (manual, no limitation) or the regular car classification license (limited to automatic), as the driver qualification information registered in the license information reference table 112b. From a viewpoint of ensuring safe driving of the vehicle, the manual driving may not be allowed for older occupants, even if the occupant has the driver qualification information which allows the manual driving.

When the image of the face of the occupant who is seated in the driver's seat of the vehicle is received as the occupant's personal information, the server 110 may acquire the occupant's personal identification information, with reference to the face image reference table 112c stored in the storage unit 112. Specifically, the server 110 acquires the occupant's personal identification information associated with the image of the face of the occupant acquired as the occupant's personal information, with reference to the face image reference table 112c.

The server 110 analyzes the image of the occupant's face acquired as the occupant's personal information, using for example, an inherent face method using principal component analysis, a linear discriminant analysis method, an elastic bunching graph matching method, a hidden Markov model method, a dynamic link matching method by neuron motivation etc.

If the server 110 cannot acquire the occupant's personal identification information based on the image of the occupant's face acquired as the occupant's personal information, the server 110 judges that the occupant does not have a driver qualification as the driver qualification information.

Further, when the biometric information possessed by the occupant who is seated in the driver's seat of the vehicle is received as the occupant's personal information, the server 110 may acquire the personal identification information, with reference to the biometric information reference table 112d stored in the storage unit 112.

For example, the server 110 acquires the occupant's personal identification information associated with the information regarding the image of the occupant's fingerprint received as the occupant's personal information, with reference to the biometric information reference table 112d. The driving mode determination unit 11b analyzes the image of the occupant's fingerprint acquired as the occupant's personal information, for example using pattern matching or minutiae matching or the like.

If the server 110 cannot acquire the occupant's personal identification information based on the occupant's biometric information acquired as the occupant's personal information, the server 110 judges that the occupant does not have a driver qualification as the driver qualification information.

Further, when the terminal identification information possessed by the occupant who is seated in the driver's seat of the vehicle is received as the occupant's personal information, the server 110 may acquire the occupant's personal identification information, with reference to the terminal reference table 112e stored in the storage unit 112.

If the server 110 cannot acquire the personal identification information based on the occupant's terminal identification information acquired as the occupant's personal information, the server 110 judges that the occupant does not have the driver qualification as the driver qualification information.

Next, in step S1509, based on the acquired occupant's personal identification information, the server 110 acquires the driver qualification information, with reference to the driver qualification information table 112a stored in the storage unit 112.

When the driver qualification information is determined using the received plurality of occupant's personal information, the server 110 may judge that the occupant does not have a driver qualification as the driver qualification information, when all the acquired driver qualification information do not match with each other.

For example, the server 110 may determine the driver qualification information based on the information held by the driver's license and the image of the occupant's face. When it is assumed that a child of the owner of the vehicle takes out an owner's driver's license and is seated in the driver's seat of the vehicle, the driver qualification information acquired based on the occupant's personal information acquired by the driver's license reader 31, and the driver qualification information acquired based on the image of the occupant's face transmitted from the camera 32, do not match with each other. Thus, when the plurality of acquired driver qualification information do not match with each other, the server 110 may not allow any occupant to operate in any driving mode. In this case, the child cannot operate the vehicle.

Further, based on the acquired occupant's personal identification information, the server 110 acquires the vehicle setting information associated with the occupant's personal identification information, with reference to the server vehicle setting table 112f stored in the storage unit 112. Further, based on the acquired occupant's personal identification information, the server 110 acquires the route history information associated with occupant's personal identification information, with reference to the server route history table 112g stored in the storage unit 112. Further, based on the acquired occupant's personal identification information, the server 110 acquires the manual driving history information associated with the occupant's personal identification information, with reference to the server manual driving history table 112h stored in the storage unit 112. Further, based on the acquired occupant's personal identification information, the server 110 acquires the automatic driving history information associated with the occupant's personal identification information, with reference so the server automatic driving history table 112j stored in the storage unit 112.

Next, in step S1511, the server 110 transmits the driver qualification information, the vehicle setting information, the route history information, the manual driving history information, and the automatic driving history information, to the vehicle control device 10 via the network N.

Next, in step S1513, the driver qualification information acquisition unit 11a receives the driver qualification information, the vehicle setting information, the route history information, the manual driving history information, and the automatic driving history information. The driver qualification information acquisition unit 11a acquires for example, information showing that the occupant does not have the regular car classification license (manual, no limitation), the regular car classification license (limited to automatic), and the regular motorcycle license etc., as the driver qualification information. In this way, in the system 100, the driver qualification information to be managed and updated in the server 110 is acquired under control of the system 1.

Next, in step S1515, the driver qualification information acquisition unit 11a registers the received vehicle setting information in the vehicle setting table 12b stored in the storage unit 12. The vehicle control device 10 adjusts the setting of the sound output unit 45 of the in-vehicle device 40 so as to correspond to the occupant, based on the vehicle setting information registered in the vehicle setting table 12b. Further, the vehicle control device 10 controls the vehicle setting control unit 80 to adjust a driving position so as to correspond to the occupant, based on the vehicle setting information registered in the vehicle setting table 12b.

Further, the driver qualification information acquisition unit 11a registers the received route history information in the route history table 12c stored in the storage unit 12, and registers the received manual driving history information in the manual driving history table 12d stored in the storage unit 12. Further, the driver qualification information acquisition unit 11a registers the received automatic driving history information in the automatic driving history table 12e stored in the storage unit 12.

When it is detected that the occupant who is seated in the driver's seat of the vehicle has unseated based on the information transmitted from the driver's seat seating information acquisition unit 20, the driving mode determination unit 11a preferably acquires the driver qualification information again by performing processing of steps S1401 and S1403 again.

The above is the description of step S1403.

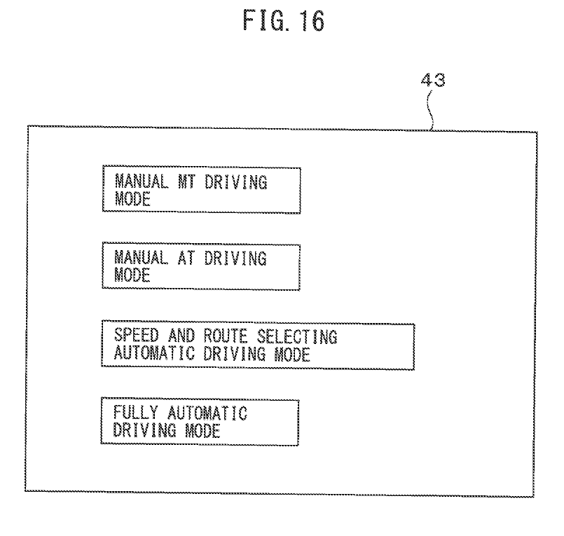

Next, in step S1405, as illustrated in FIG. 16, the driving mode determination unit 11b displays all selectable driving modes in the vehicle, on the display unit 43 of the in-vehicle device 40. The occupant who is seated in the driver's seat of the vehicle, selects one of the driving modes displayed on the display unit 43 by using the operation unit 44 of the in-vehicle device 40. Then, the driving mode selected by the occupant is input in the driving mode determination unit 11b. The driving mode determination unit 11b may display only the allowable driving mode for the occupant, on the display unit 43 based on the occupant's personal information.

Next, in step S1407, the destination desired by the occupant seated in the driver's seat is inputted in the route determination unit 11c of the processing unit 11 of the vehicle control device 10, using the operation unit 44 of the in-vehicle device 40.

The occupant who is seated in the driver's seat inputs the destination using the operation unit 44 of the in-vehicle device 40. Further, the occupant who has selected the speed and the route selecting automatic driving mode may input the desired speed or route, using the operation unit 44 of the in-vehicle device 40.

Next, in step S1409, the route determination unit 11c derives the route from the current position of the vehicle to the destination, using the in-vehicle device 40. The route determination unit 11b attempts to derive the routes only via roads allowed to run by automatic driving, when the driving mode selected by the occupant is the speed and route selecting automatic driving mode or the fully automatic driving mode. When it is impossible to derive the routes only via the roads allowed to run by automatic driving, or when the destination is not connected to the roads allowed to run by automatic driving, the route determination unit 11e derives alternative routes including the roads not allowed to run by automatic driving. The route determination unit 11c may derive the route depending on the occupant, with reference to the route history information registered in the route history table 12c stored in the storage unit 12.

Next, in step S1411, the driving mode determination unit 11b determines whether or not the selected driving mode can be allowed on the route to the derived destination based on the driver qualification information.

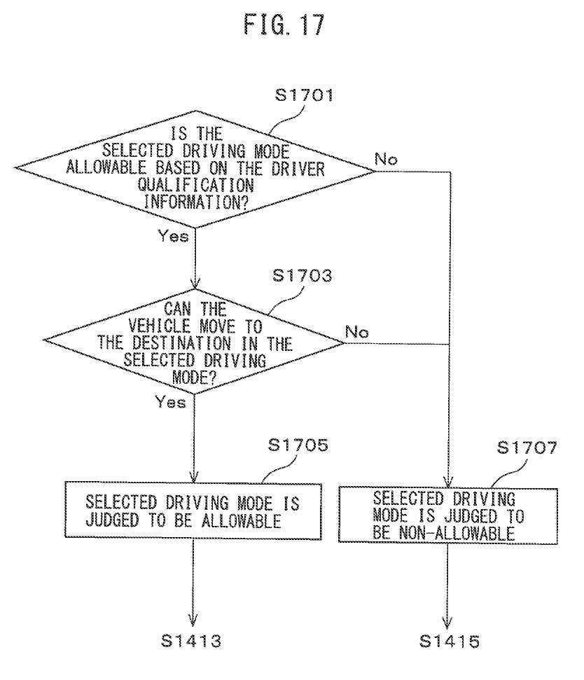

FIG. 17 is a diagram for explaining the processing of the DRIVING mode determination unit 11b in step S1411.

First, in step S1701, the driving mode determination unit 11b judges whether or not the driving mode selected by the occupant is allowed, based on the driver qualification information.

For example, when the occupant who has the regular car classification license (manual, no limitation) as the driver qualification information selects the manual MT driving mode, this selection is allowed (Yes in step S1701). On the other hand, when the occupant having the regular car classification license (limited to automatic) as the driver qualification information selects the manual MT driving mode, this selection is not allowed (No in step S1701). Further, when the occupant having the regular motorcycle license as the driver qualification information selects the speed and route selecting automatic driving mode, this selection is allowed (Yes in step S1701). On the other hand, when the occupant having the regular car classification license (limited to automatic) as the driver qualification information selects the manual MT driving mode or the manual AT driving mode, this selection is not allowed (No in step S1701). Further, when the occupant who does not have a driver qualification as the driver qualification information selects the fully automatic driving mode, this selection is allowed (Yes in step S1701). On the other hand, when the occupant who does not have a driver qualification as the driver qualification information selects the manual MT driving mode, the manual AT driving mode, or the speed and the route selecting automatic driving mode, this selection is not allowed (No in step S1701).

When the occupant does not have a driver qualification as the driver qualification information, the driving mode determination unit 11b may determine the driving mode so that, the fully automatic driving mode is allowed or no one of the driving modes is allowed for the occupant, among the abovementioned four driving modes. The occupant who is not allowed to drive the vehicle in any one of the abovementioned driving modes, cannot operate the vehicle.

Next, in step S1703, the driving mode determination unit 11b judges whether or not the vehicle can move to the destination in the selected driving mode (Yes in step S1701).

For example, when the manual MT driving mode or the manual AT driving mode is allowed for the occupant, the driving mode determination unit 11b judges that the vehicle can move using the derived route (Yes in step S1703). This is because even when the route includes the road not allowed to run by automatic driving or the destination is not connected to the road allowed to run by automatic driving, it is considered that running by manual driving is possible. On the other hand, when the speed and route selecting automatic driving mode or the fully automatic driving mode is allowed, and when the derived route includes the road not allowed to run by automatic driving or the destination is not connected to the road allowed to run by automatic driving, the driving mode determination unit 11b judges that the vehicle cannot move to the destination in the selected driving mode (No in step S1703). Thus, by determining the driving mode and determining the route based on the occupant's driver qualification information, the driving based on the allowable driving mode is ensured so that the vehicle can run on the route. Specifically, when the driving mode is the speed and route selecting automatic driving mode or the fully automatic driving mode, the route to the destination is determined based on the driver qualification information.

In step S1705, the driving mode determination unit 11b judges that the selected driving mode can be allowed (Yes in step S1703).

Next, in step S1413 (see FIG. 14), the driving mode determination unit 11b determines the driving mode selected by the occupant as the driving mode for the occupant to control the vehicle. The driving mode determination unit 11b causes the drive control device 60 to control the operation of the vehicle by the determined driving mode.

When the manual MT driving mode or the manual AT driving mode is allowed, the information updating unit 11d of the processing unit 11 of the vehicle control device 10 acquires the occupant's operation information from the driving control device 60 and updates the manual driving history table 12d, during manual driving of the vehicle.

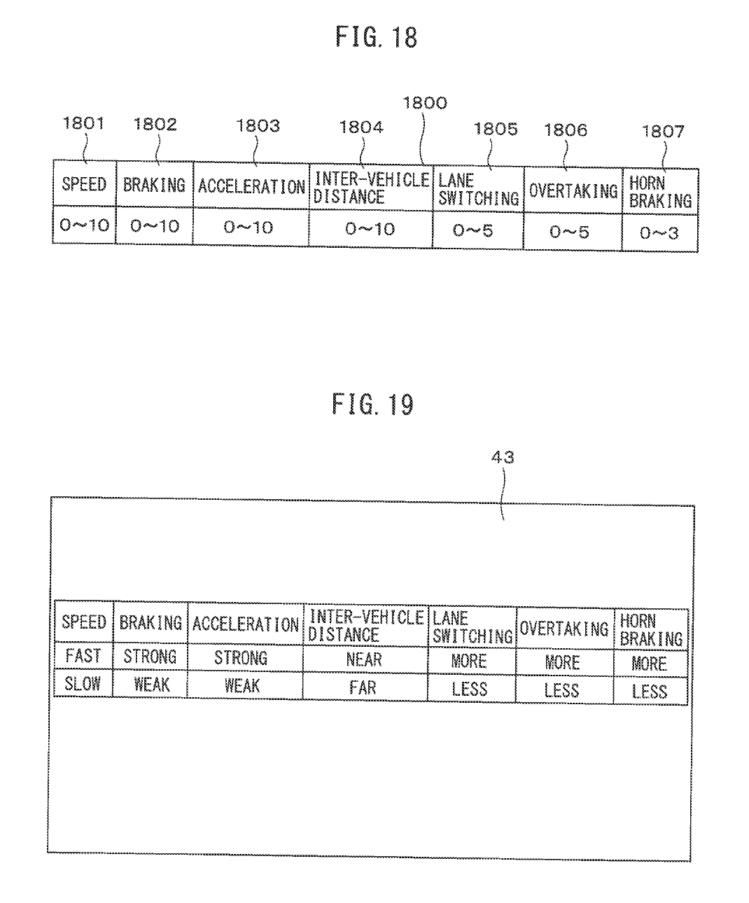

FIG. 18 is a diagram illustrating an example of the manual driving history table.

The manual driving history table 1800 includes a speed field 1801, a braking field 1802, an acceleration field 1803, an inter-vehicle distance field 1804, a lane switching field 1804, an overtaking field 1806, and a horn field 1807.

The information updating unit 11d updates the speed field 1801 to a value obtained by digitizing the vehicle speed in a predetermined range based on the running of the vehicle. The information updating unit 11d updates the braking field 1802 to a value obtained by digitizing the frequency of a brake operation in a predetermined range based on the occupant's operation information. The information updating unit 11d updates the acceleration field 1803 to a value obtained by digitizing the frequency of the accelerator operation in a predetermined range based on the occupant's operation information. The information updating unit 11d updates the inter-vehicle distance field 1804 to a value obtained by digitizing an inter-vehicle distance in a predetermined range based on the running of the vehicle. The information updating unit 11d updates the lane switching field 1804 to a value obtained by digitizing the frequency of lane switching in a predetermined range based on the running of the vehicle and the occupant's operation information. The information updating unit 11d updates the overtaking field 1806 to a value obtained by digitizing the frequency of overtaking in a predetermined range based on the running of the vehicle and the occupant's operation information. The information updating unit 11d updates the horn column 1807 to a value obtained by digitizing the frequency of the horn sounding in a predetermined range based on the occupant's operation information based on the occupant's operation information.

On the other hand, when the speed and route selecting automatic driving mode or the fully automatic driving mode is allowed, the information updating unit 11d of the processing unit 11 of the vehicle control device 10 acquires automatic driving evaluation information from the occupant aboard the vehicle in the automatic driving mode, during automatic driving of the vehicle.

FIG. 19 is a diagram illustrating a screen of a display unit when acquiring automatic driving evaluation information.

The information updating unit 11d displays evaluation information for evaluating each item on the display unit 43 of the in-vehicle device 40, along with the vehicle speed, braking, acceleration, inter-vehicle distance, lane changeover, overtaking, and horn, which are automatic driving evaluation items.

The occupant selects the evaluation information for evaluating each automatic driving evaluation item, using the operation unit 44 of the in-vehicle device 40.

The occupant selects fast or slow as the evaluation information for evaluating the speed. The occupant selects strong or weak as the evaluation information for evaluating the braking. The occupant selects strong or weak as the evaluation information for evaluating acceleration. The occupant selects near or far as the evaluation information for evaluating the inter-vehicle distance. The occupant selects more or less as the evaluation information for evaluating the lane change. The occupant selects more or less as the evaluation information for evaluating the overtaking. The occupant selects more or less as the evaluation information for evaluating the horn sounding.

The information updating unit 11d acquires the occupant's evaluation information for each automatic driving evaluation item, using the operation unit 44.

The information updating unit 11d updates the automatic driving history table 12e stored in the storage unit 12 based on the acquired automatic driving evaluation information.

The information updating unit 11d controls the automatic driving of the driving control device 60 based on the automatic driving evaluation information registered in the automatic driving history table 12e, together with the manual driving information registered in the manual driving history table 11d. Further, the information updating unit 11d updates the information of the vehicle setting table 12b of the storage unit 12, when the occupant changes the setting of the sound output unit 45 of the in-vehicle device 40 or changes the setting of the driving position.

The above is the description of step S1413.

On the other hand, in step S1707, the driving mode determination unit 11b judges that the selected driving mode cannot be allowed (No in step S1701 or S1703).

Next, in step S1415 (No in step S1411), the driving mode determination unit 11b judges presence or absence of other allowable driving mode.

For example, in step S1411, it is assumed that the occupant having the regular car classification license (manual, no limitation) as the driver qualification information selects the speed and route selecting automatic driving mode or the fully automatic driving mode, and an alternative route is derived to the destination including the road that is not allowed to run by automatic driving. In this case, the driving mode determination unit 11b judges that there are the manual MT driving mode and the manual AT driving mode as the allowable driving modes for the occupant (Yes in step S1415). It can be considered that this is because in a case of the occupant who has the driver qualification information including the manual MT driving mode and the manual AT mode, the vehicle can be safely driven to the destination by running on the alternate route by manual driving.

Further, in step S1411, it is assumed that the occupant who does not have a driver qualification as the driver qualification information selects the speed and route selecting automatic driving mode to derive the route to the destination via only the road allowed to run by automatic driving. In this case, the driving mode determination unit 11b judges that there is the fully automatic driving mode as the allowable driving mode for the occupant (Yes in step S1415). Only the operation of inputting the destination is allowed for the occupant who does not have a driver qualification, so that safe driving of the vehicle can be ensured.

Further, in step S1411, when the occupant who does not have a driver qualification as the driver qualification information selects the manual MT driving mode or the manual AT driving mode, and when the route can be derived to the destination via only the road allowed to run by automatic driving, the driving mode determination unit 11b judges that there is the fully automatic driving mode as the allowable driving mode for the occupant (Yes in step S1415). Only the operation of inputting the destination is allowed for the occupant who does not have a driver qualification, so that safe running of the vehicle can be ensured.

On the other hand, when there is no allowable driving mode as the driver qualification information possessed by the occupant, the driving mode determination unit 11b judges that there is no other allowable driving mode (No in step S1415). For example, there is sometimes a case that the occupant who does not have a driver qualification as the driver qualification information selects the fully automatic driving mode but cannot derive the route to the destination via only the road allowed to run by the automatic driving.

In step S1417, the driving mode determination unit 11b notifies the occupant of the allowable driving mode (Yes in step S1415). The driving mode determination unit 11b displays, for example, the allowable driving mode on the display unit 43 of the in-vehicle device 40, or outputs an allowable driving mode by voice using the sound output unit 45.

Next, in step S1419, the occupant inputs the allowable driving mode in the driving mode determination unit 11b, using the operation unit 44 of the in-vehicle device 40. When the notified allowable driving mode is not selected, the occupant who is seated in the driver's seat performs operation of not selecting the allowable driving mode using the operation unit 44 (No in step S1419).

Next, in step S1421, the driving mode determination unit 11b determines the driving mode input by the occupant as the driving mode for the occupant to control the vehicle. The driving mode determination unit 11b causes the operation control device 60 to control the operation of the vehicle in the determined driving mode.

On the other hand, in step S1423, the driving mode determination unit 11b notifies the occupant that the vehicle cannot be operated (No in step S1415 or S1419). The driving mode determination unit 11b displays, for example, a message showing that the vehicle cannot be driven using the display unit 43 of the in-vehicle device 40, or outputs this message by voice using the sound output unit 45.

The above is the description of the operation for determining the driving mode by the vehicle control device 10.

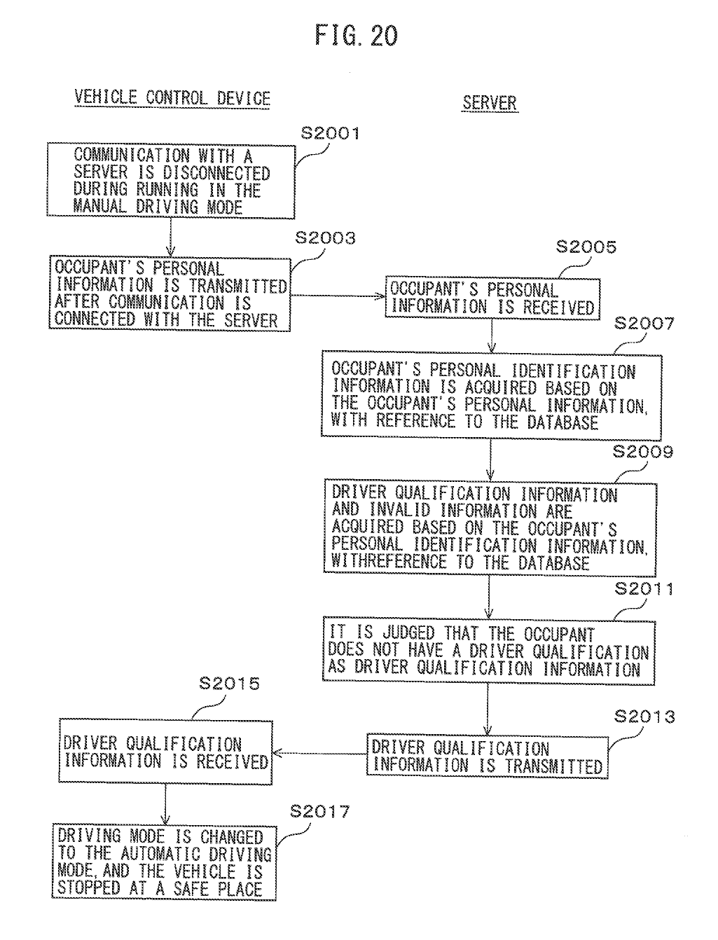

Even after determining the driving mode for the occupant, the vehicle control device 10 communicates with the server 110 via the network N at predetermined intervals, for example. The vehicle control device 10 transmits the information registered in the vehicle setting table 12b, the route history table 12c, the manual driving history table 12d and the automatic driving history table 12e stored in the storage unit 12, to the server 110 together with the occupant's personal information. The server 110 acquires the occupant's personal identification information based on the occupant's personal information, and registers various received information in the server vehicle setting table 112f of the storage unit 112, the server route history table 112g, the server manual driving history table 112h, and the server automatic driving history table 112i in association with the occupant's personal identification information. When the communication with the server 110 is disconnected, the vehicle control device 10 acquires the occupant's driver qualification information by repeating the processing of steps S1401 and S1403. The operation of the vehicle control device 10 when communication with the server 110 is disconnected during manual driving will be described hereafter, with reference to FIG. 20.

First, in step S2001, it is assumed that the communication between the vehicle control device 10 and the server 110 is disconnected while the vehicle driven by the occupant is running in the manual driving mode.

Next, in step S2003, after the communication with the server 110 is connected, the driver qualification information acquisition unit 11a transmits the occupant's personal information to the server 110 via the network N.

Next, in step S2005, the server 110 receives the occupant's personal information.

Next, in step S2007, the server 110 acquires the driver qualification information possessed by the occupant who is seated in the driver's seat of the vehicle, based on the received occupant's personal information, with reference to the storage unit 112.

Next, in step S2009, the server 110 acquires the driver qualification information, based on the acquired occupant's personal identification information with reference to the driver qualification information table 112a stored in the storage unit 112.

It is assumed that the driver qualification-related information registered in the driver qualification information table 112a in association with the occupant's personal identification information, includes invalid information. This is because while the communication is disconnected, the server 110 acquires the driver qualification-related information from the server 120 of the public institution so that the driver qualification information table 112a is updated, thereby also registering the invalid information as the driver qualification-related information. It is conceivable that the invalid information is registered as the driver qualification-related information, for example, for the reason that the driver's license associated with the occupant's personal identification information is stolen or the like.

Next, in step S2011, when the driver qualification-related information includes the invalid information, the server 110 judges that the occupant does not have a driver qualification as the driver qualification information irrespective of the information registered as the driver qualification information.

Next, in step S2013, the server 110 transmits the driver qualification information to the vehicle control device 10 via the network N.

Next, in step S2015, the driver qualification information acquisition unit 11a receives the driver qualification information.

Next, in step S2017, when it is judged that the received driver qualification information is different from the driver qualification information before disconnection, the driver qualification information acquisition unit 11a switches the driving mode of the vehicle to the automatic driving mode, and stops the vehicle at a safe place. Thereafter, the vehicle control device 10 may acquire the destination from the occupant and move the vehicle to the destination in the automatic driving mode.

The above is a description of the operation of the vehicle control device 10 when communication with the server 110 is disconnected during manual driving.

The occupant who is seated in the driver's seat of the vehicle sometimes wants to use the vehicle at a place away from the vehicle. For example, the occupant moves the vehicle to the current position where the occupant is present and then board the vehicle and moves to the destination in some cases.

When only the automatic driving mode is allowed as the occupant's driver qualification information, the vehicle cannot move to the destination from the current position in some cases. This is because when the derived route to the destination includes the road, not allowed to run by automatic driving, or the destination is not connected to the road allowed to run by automatic driving, the vehicle cannot move to the destination by automatic driving.

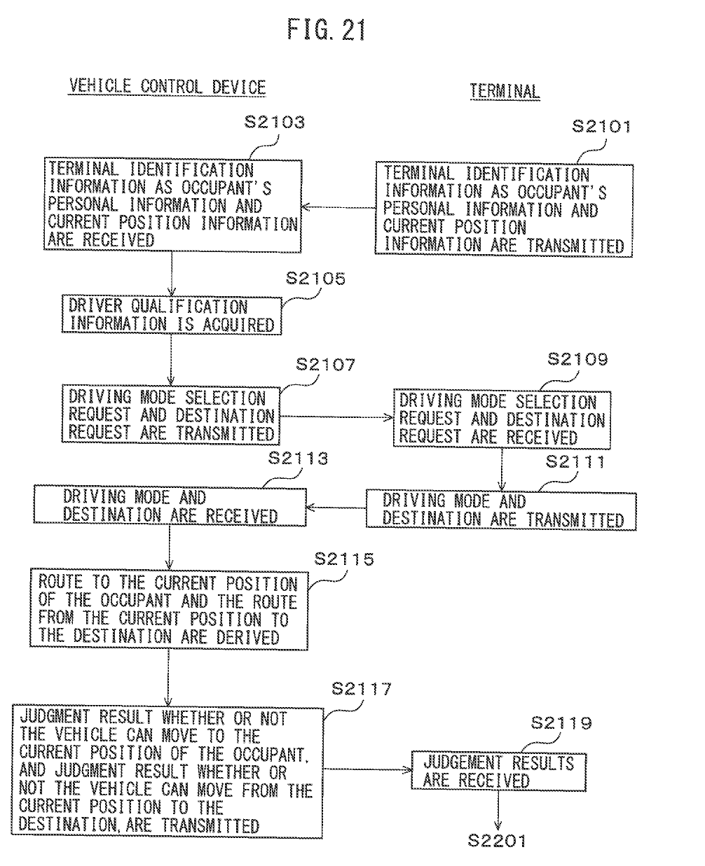

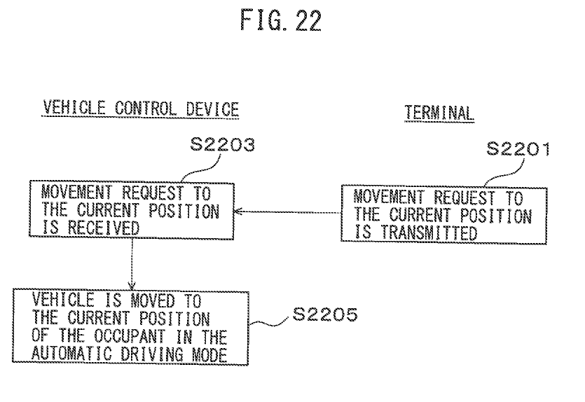

The operation of the vehicle control device 10 in a case that the occupant who is outside the vehicle moves the vehicle to the current position and then boards the vehicle and moves to the destination, will be described hereafter, with reference to FIG. 21 and FIG. 22.

First, in step S2101, the occupant who is outside the vehicle transmits the terminal identification information as the occupant's personal information and the current position information to the vehicle control device 10 via the network N, using the terminal 130.

Next, in step S2103, the vehicle control device 10 receives the terminal identification information as the occupant's personal information and the current position information.

Next, in step S2105, the driver qualification information acquisition unit 11a of the processing unit 11 of the vehicle control device 10 transmits the terminal identification information as the occupant's personal information to the server 110 and acquires the driver qualification information.

Next, in step S2107, the driving mode determination unit 11b and the route determination unit 11c of the processing unit 11 of the vehicle control device 10, transmits a driving mode selection request and a destination request to the terminal 130 via the network N.

Next, in step S2109, the terminal 130 receives the driving mode selection request and the destination request.

Next, in step S2111, the occupant who is outside the vehicle transmits the driving mode and the destination to be selected using the terminal 130, to the vehicle control device 10 via the network N.

Next, in step S2113, the vehicle control device 10 receives the driving mode and the destination.

Next, in step S2115, the route determination unit 11c of the vehicle control device 10 attempts to derive the route from the current position of the vehicle to the current position of the occupant via only the road allowed to run by automatic driving. Further, the route determination unit 11c derives the route from the current position of the occupant to the destination.

Next, in step S2117, the driving mode determination unit 11b of the vehicle control device 10 judges whether or not the vehicle can move from the current position of the vehicle to the current position of the occupant by automatic driving. The driving mode determination unit 11b judges that the vehicle can move from the current position of the vehicle to the current position of the occupant as long as the vehicle can run by automatic driving through the route from the current-position of the vehicle to the current position of the occupant. Otherwise, the driving mode determination unit 11b judges that the vehicle cannot move.

Further, when the vehicle can move from the current position of the vehicle to the current position of the occupant, the driving mode determination unit 11b judges whether or not the vehicle can move on the route from the current position of the occupant to the destination in the selected driving mode, based on the driver qualification information.

Then, the driving mode determination unit 11b transmits a judgment result as to whether or not the vehicle can move from the current position of the vehicle to the current position of the occupant, and a judgment result as to whether or not the vehicle can move in the selected driving mode from the current position of the occupant to the destination, to the terminal 130 via the network N. When the vehicle cannot move in the selected driving mode from the current position of the occupant to the destination, the driving mode determination unit 11b transmits mobility information indicating how far the vehicle can move on the route from the current position of the occupant to the destination, together with the judgment result.

When the vehicle cannot move from the current position of the vehicle to the current position of the occupant by automatic driving, the judgment result as to whether or not the vehicle can move in the selected driving mode from the current position of the occupant to the destination, is not transmitted to the terminal 130.

Following explanation will be given hereafter, on the assumption that the vehicle can move from the current position of the vehicle to the current position of the occupant by automatic driving.

Next, in step S2119, the terminal 130 receives the judgment result as to whether or not the vehicle can move from the current position of the vehicle to the current position of the occupant, and the judgment result as to whether or not the vehicle can move in the selected driving mode from the current position of the occupant to the destination.

The occupant who is outside the vehicle judges whether or not to move the vehicle to the current position where the occupant is present, based on the judgment result as to whether or not the vehicle can move in the selected driving mode from the current position of the occupant to the destination.

For example, it is assumed that the occupant who is outside the vehicle does not nave a driver qualification as the driver qualification information. In addition, it is assumed that the occupant who is outside the vehicle has received the judgment result notifying that the vehicle cannot move in the selected driving mode from the current position of the occupant to the destination. Then, the occupant who is outside the vehicle obtains information on how far the vehicle can move on the route from the current position of the occupant to the destination based on the received mobility information together with the judgment result. The occupant who is outside the vehicle can judge whether to use the vehicle or a public transport such as a train or a taxi to move to the destination, based on the mobility information. In the case of using the vehicle of automatic driving, even if the vehicle cannot move to the destination, it may be better to choose to use the vehicle as long as the vehicle can move to the vicinity of the destination. On the other hand, when the position to which the occupant can move by using the vehicle of automatic driving is far from the destination, it is better to choose to use the public transport in some cases. The following explanation will be given, on the assumption that the occupant who is outside the vehicle chooses to move by using the vehicle.

Next, in step S2201, the occupant who is outside the vehicle transmits a movement request to the vehicle control device 10, for requesting to move the vehicle to the current position where the occupant is present, via the network N using the terminal 130.

Next, in step S2203, the vehicle control device 10 receives the movement request.

Next, in step S2205, the vehicle control device 10 moves the vehicle to the position of the occupant who is outside the vehicle in the automatic driving mode.

The above is the description of the operation of the vehicle control device 10 when the occupant who is outside the vehicle moves the vehicle to the current position and then boards the vehicle and moves to the destination.

Next, the operation of an electronic settlement unit 11e of the processing unit 11 of the vehicle control device 10 will be described hereafter.

In the system 1, when the vehicle runs on a toll road, the electronic settlement unit 11e performs wireless communication with a wireless communication apparatus disposed at a toll gate by using the communication unit 13, to thereby make electronic payment for fee payment. For example, when the vehicle runs on the toll road in the automatic driving mode, the electronic settlement unit 11e performs fee payment processing, and therefore the occupant is not required to perform fee payment procedures.

Further, the vehicle may be used as a taxi in the automatic driving mode. The occupant who is a user of a taxi, can move to the destination by automatic driving by inputting the destination in the system 1. In this case, the electronic settlement unit 11e is set so that electronic payment can be made for payment of usage fee from the occupant. For example, the occupant may purchase on the web a pre-paid taxi ticket associated with the occupant's personal identification information. In this case, the occupant can use the taxi within a range of an amount of a taxi ticket purchased in advance. Further, the occupant may register the occupant's credit card number in association with the occupant's personal identification information in the driver qualification information table 112a of the storage unit 112 of the server 110. The occupant can make a reservation of the taxi and notification of the destination to the system 1, using the terminal 130. After the occupant uses the taxi, the electronic settlement unit 11e performs electronic settlement of the taxi usage fee based on the occupant's credit card number.

According to the abovementioned system 100 of this embodiment, an allowable operation range of the vehicle having the automatic driving mode can be determined, based on the driver qualification information possessed by the occupant who drives the vehicle.

Since the server 110 updates the occupant's driver qualification information together with the driver qualification-related information, accurate driver qualification information and driver qualification-related information are acquired, and the allowable driving mode for the occupant is determined.

Further, according to the system 100, the operation range tor operating the vehicle is automatically determined in the manual driving mode based on the driver qualification information possessed by the occupant who drives the vehicle, and therefore safe running of the vehicle is ensured within a range corresponding to the skill of the occupant.

Further, according to the system 100, the operation other than the operation of inputting the destination is not allowed for the occupant who does not have a driver qualification as the driver qualification information, and therefore running of the vehicle by automatic driving mode can be ensured by preventing the occupant's manual operation.

In the present invention, the vehicle control network system, the vehicle control system, the vehicle control device, and the vehicle control method of the abovementioned embodiments can be appropriately modified without departing from the gist of the present invention.

For example, in the abovementioned embodiments, the route is derived by the in-vehicle device 40 under the control of the vehicle control device 10, but the route may also be derived by the vehicle control device 10.

Further, in the system 100, the automatic driving mode for performing automatic driving based on previously registered automatic driving information (time zone and route etc.) may be allowed, in association with the occupant's personal identification information. For example, the fully automatic driving mode based on the automatic driving information (time zone, route, etc.) may be registered in the driver qualification information table 112a of the storage unit 112 of the server 110, in association with the occupant's personal identification information. In this fully automatic driving mode, the vehicle is controlled so as to move on a predetermined route in a predetermined time zone. Such a setting can be used, for example, when using a vehicle to pick up and drop children at a children's school in the morning and evening. Thus, the occupant can move to the destination by causing the driver's license reader 31 to read the driver's license.

There is a possibility that the type of the license and the driver qualification are changed due to future revisions of traffic rules or the like. For example, an “automatic driver's license” may be created so that certain knowledge is required for traffic rules and the like even if driving operation cannot be done, and in such a case, even in the fully automatic driving, if some qualified drivers are not on board, there is a possibility that running will not be allowed. Therefore, the server 110 according to the modified example can update the license information reference table 112b stored in the storage unit 112 so as to cope with such a revision of the traffic rules or the like. Specifically, the type of the driver's license/driver qualification information added or changed by revision can be input by a server administrator using an input unit not illustrated, or may be read from an information medium (CD-ROM, USB memory, etc.) by a read unit (not illustrated), or may be acquired from the public server 120 via the network N. In this way, even if the traffic rules or the like are changed in the future, the operation range for allowing the operation of the vehicle having the automatic driving mode, can be appropriately determined based on the driver qualification information possessed by the occupant.

1. A vehicle control device including a plurality of driving modes with different allowable operation ranges to operate a vehicle, the plurality of driving modes including at least an automatic driving mode, the device comprising:
a processing unit that determines to operate a vehicle in any one of the plurality of driving modes based on driver qualification information possessed by an occupant who operates the vehicle.

2. The vehicle control device according to claim 1, wherein the processing unit acquires the driver qualification information based on information held by a driver's license possessed by the occupant.

3. The vehicle control device according to claim 2, wherein the processing unit acquires the driver qualification information by referring to a correspondence table that stores a correspondence between information held by the driver's license possessed by the occupant and the driver qualification information, and updates the correspondence table.

4. The vehicle control device according to claim 1, wherein when the driving mode is an automatic driving mode, the processing unit determines a route to a destination based on the driver qualification information.

5. The vehicle control device according to claim 1, wherein the processing unit determines that a vehicle is to be operated in any one of the plurality of driving modes based the driver qualification information and an age of the occupant.

6. The vehicle control device according to claim 1, wherein the processing unit acquires the driver qualification information from an external server.

7. The vehicle control device according to claim 6, comprising:
an occupant's personal information acquisition unit that acquires occupant's personal information for identifying the occupant; and
a communication unit that transmits the occupant's personal information acquired by the occupant's personal information acquisition unit to the server and receives the driver qualification information associated with the occupant's personal information from the server.

8. The vehicle control device according to claim 6, wherein the server updates the driver qualification information based on information acquired from outside.

9. The vehicle control device according to claim 6, wherein the occupant is outside the vehicle including the vehicle control device, and the processing unit notified of a current position of the occupant and a destination from the occupant, notifies the occupant of a judgment result as to whether or not the vehicle can move from the current position of the occupant to the destination, based on the driver qualification information.

10. A vehicle control method, comprising:
determining to operate a vehicle by a processing unit in any one of a plurality of driving modes with different allowable operation ranges for an occupant to operate the vehicle, based on driver qualification information possessed by the occupant who operates the vehicle, the driving modes including at least an automatic driving mode; and
controlling the vehicle by the processing unit based on the determined driving mode.

11. The vehicle control method according to claim 10, wherein the processing unit acquires the driver qualification information from an external server.
